(19) United States
(12) Patent Application Publication
(10) Pub. No.: US 2009/0109351 A1
(43) Pub. Date: Apr. 30, 2009

(54) Liquid Crystal Display Device And Television Receiver

(76) Inventor: Makoto Shiomi, Tenri-shi Nara (JP)

Correspondence Address: HARNESS, DICKEY & PIERCE, P.L.C., P.O. BOX 8910, RESTON, VA, 20195, US

(21) Appl. No.: 12/225,183

(22) PCT Filed: Dec. 11, 2006
(86) PCT No.: PCT/JP2006/324644

§ 371 Date: Sep. 16, 2008

(30) Foreign Application Priority Data
Mar. 22, 2006 (JP) 2006-079778

(51) Int. Cl. H04N 3/14; G09G 3/36

(52) U.S. Cl. 348/790; 345/87; 348/E03.016

(57) ABSTRACT

In one embodiment of the present invention, a liquid crystal display device with two liquid crystal panels or more overlapped with each other, the maximum brightness is worked out for each sub-block of an input signal (i.e., a gray scale signal) in a sub-block brightness confirming section. Further, the most suitable index corresponding to the maximum brightness is generated (the most suitable γ value is judged) in a most suitable index generating section. After the most suitable index is generated, the most suitable index is compared with an index which is set for the sub-block immediately before a current and an LCD1LUT and an LCD2LUT are switched to carry out γ corrections in a comparing generating section.

### TECHNICAL FIELD

The present invention relates to a liquid crystal display device having improved contrast and a television receiver including the same.

### BACKGROUND ART

As an art for improving contrast in a liquid crystal display device, for example, Patent Document 1 discloses a complex liquid crystal display device in which two LCD (Liquid Crystal Display) panels are overlapped with each other. That is, Patent Document 1 describes that overlapping two LCD panels emphasizes a gap between light and dark in the LCD panels, so as to improve contrast.

Also, Patent Document 1 suggests that the complex liquid crystal display device disclosed in Patent Document 1 can obtain a large number of gray scales for displaying. The number of gray scales is a product obtained by multiplying gray scales of one LCD panel by gray scales of the other LCD panel, which LCD panels being overlapped with each other. For example, it is possible to display in fine gray scales of 256 in a device which has a pair of LCD panels being overlapped with each other, each of the LCD panels being capable of displaying in 16 gray scales.

[Patent Document 1]

Japanese Unexamined Patent Application Publication, Tokukaihei, No. 5-88197 (published on Apr. 9, 1993)

[Patent Document 2]

Japanese Unexamined Patent Application Publication, Tokukai, 2004-54250 (published on Feb. 19, 2004)

[Patent Document 3]

Japanese Unexamined Patent Application Publication, Tokukai, 2004-117752 (published on Apr. 15, 2004)

[Patent Document 4]

Japanese Unexamined Patent Application Publication, Tokukai, 2002-131775 (published on May 9, 2002)

### DISCLOSURE OF INVENTION

Patent Document 1, however, discloses a complex liquid crystal display device which is considered to be a device for basically carrying out monochrome displaying, and does not describe a liquid crystal display device for carrying out color displaying. In addition, it is difficult for the complex liquid crystal display device to actually carry out color displaying in such fine gray scales as described above.

In the complex liquid crystal display device disclosed in Patent Document 1, the same display signal is inputted to two LCD panels which are overlapped with each other. In a case where these panels are color panels, a color shift will occur in display light by the following reason: When the two LCD panels thus overlapped are color panels, display light which proceeds diagonally to a normal direction of the panel sometimes goes through two pixels having different colors.

The present invention has been made in view of the foregoing problems, and has an object for allowing a liquid crystal display device including two liquid crystal panels which are overlapped with each other to display in colors with fine gray scales.

In order to attain the object, a liquid crystal display device in accordance with the present invention is a drive method for a liquid crystal display device including: (i) two or more liquid crystal panels being overlapped with each other, each of the liquid crystal panels outputting an image in accordance with an image source; and (ii) polarized light absorbing layers sandwiching the liquid crystal panels therebetween, the polarized light absorbing layers being arranged in a crossed Nicols state, wherein one liquid crystal panel of the liquid crystal panels being overlapped with each other is a first panel that carries out a brightness adjustment and the other liquid crystal panel is a second panel that carries out color displaying, and a γ value in each display signal being outputted to the first panel and the second panel is changed in accordance with a gray scale in the image source.

In this arrangement, the polarized light absorbing layer is arranged in a crossed Nicols state with a polarized light absorbing layer of the liquid crystal panel, the polarized light absorbing layers adjoining each other. This gives the effects such as: (i) In a view from the front, when leakage light occurs in a direction of a transmission axis of the polarized light absorbing layer, the leakage light is shut off by an absorption axis of the other polarized light absorbing layer; (ii) In a view from an oblique angle, even if a Nicol angle is broken (the Nicol angle is an angle created by the cross of the polarization axes of the polarized light absorbing layers adjoining each other), the amount of light caused by leakage light does not increase. That is, when a Nicol angle becomes large at an oblique viewing angle, black is less apt to be grayish.

Thus, when two or more liquid crystal panels are overlapped with each other, the number of polarized light absorbing layers is not less than three. That is, it is possible to largely improve shutter performance both in a view from the front and in a view from an oblique angle by having three polarized light absorbing layers being arranged in a crossed Nicols state with each other. This improves contrast significantly.

One liquid crystal panel out of the liquid crystal panels being overlapped with each other is a first panel that carries out a brightness adjustment, and the other liquid crystal panel is a second panel that carries out color displaying. In this case, a γ value in each display signal being outputted to the first panel and the second panel is changed in accordance with the gray scale in an image source.

For example, the first panel has a gray scale-brightness characteristic being represented in a reverse-S shape, in which (i) a γ value on a lower gray scale side is relatively lower and (ii) a γ value on a higher gray scale side is relatively higher. On the other hand, the second panel has a gray scale-brightness characteristic being represented in an S shape, in which (iii) a γ value on a lower gray scale side is relatively higher and (iv) a γ value on a higher gray scale side is relatively lower. Each the γ value of the panels changes at X gray scale which is properly determined, for example, in the vicinity of 224 gray scales. When display brightness is high, brightness in the vicinity of X gray scale is set to become relatively high in the first panel. For example, when the maximum input gray scale is 64, the value of 64 is changed to a value in the vicinity of X (for example, 220) by a γ value changing table of the first panel.

A γ value of the second panel is set so that a desired γ-curve (for example, 2.2) can be obtained in accordance with the gray scale-brightness characteristic of the first panel. With such setting, a gray scale more than X gray scale cannot obtain a sufficient brightness resolution. However, considering what this setting intends to, such a gray scale rarely occurs. In addition, if such a gray scale error occurs, the error may be permitted. In other words, a small error cannot be recognized because a partial region where a high gray scale exists is shining while the entire panel is dark.

On the other hand, when the maximum gray scale is high, brightness for X gray scale is also set almost at maximum. That is, a gray scale-brightness characteristic having higher brightness is selected. In such a gray scale-brightness characteristic, for example, 224 gray scales are changed into 248 gray scales. Thus, a gray scale-brightness characteristic of the second panel is corrected so as to obtain desired brightness.

As described above, a gray scale-brightness characteristic of the first panel is dynamically changed in accordance with display brightness. This allows the second panel to achieve sufficient gray scale resolution corresponding to various levels of brightness.

### BRIEF DESCRIPTION OF DRAWINGS

FIG. 1 illustrates one of the embodiments of the present invention, and is a block diagram illustrating major parts of a liquid crystal display device.

FIG. 2 is a schematic cross-sectional view of a liquid crystal display device having one liquid crystal panel.

FIG. 3 is a view illustrating an arrangement of polarization plates and a panel in the liquid crystal display device illustrated in FIG. 2.

FIG. 4 (a) to (c) are a view illustrating a principle of an improvement in contrast.

FIG. 5 (a) to (d) are a view illustrating a principle of an improvement in contrast.

FIG. 6 (a) to (c) are a view illustrating a principle of an improvement in contrast.

FIGS. 7 (a) and (b) are a view illustrating a principle of an improvement in contrast.

FIG. 8 (a) to (c) are a view illustrating a principle of an improvement in contrast.

FIGS. 9 (a) and (b) are a view illustrating a principle of an improvement in contrast.

FIGS. 10 (a) and (b) are a view illustrating a principle of an improvement in contrast.

FIG. 11 is a schematic cross-sectional view of a liquid crystal display device having two liquid crystal panels.

FIG. 12 is a view illustrating an arrangement of polarization plates and panels in the liquid crystal display device illustrated in FIG. 11.

FIG. 13 is a plan view of a vicinity of a pixel electrode in the liquid crystal display device illustrated in FIG. 11.

FIG. 14 is a schematic block diagram of a drive system driving the liquid crystal display device illustrated in FIG. 11.

FIG. 15 is a view illustrating a connection between a driver and a panel drive circuit in the liquid crystal display device illustrated in FIG. 11.

FIG. 16 is a schematic block diagram of a backlight in the liquid crystal display device illustrated in FIG. 11.

FIG. 17 is a block diagram illustrating a display controller, which is a drive circuit driving the liquid crystal display device illustrated in FIG. 11.

FIG. 18 is a view illustrating a principle of occurring a color shift in a liquid crystal display device having two liquid crystal panels being overlapped with each other.

FIGS. 19 (a) and (b) are a view illustrating a plurality of γ-curves being prepared in a first panel and a second panel.

FIGS. 20 (a) and (b) are a view illustrating a plurality of γ-curves being prepared in a first panel and a second panel.

FIG. 21 is a schematic block diagram of a television receiver including a liquid crystal display device of the present invention.

FIG. 22 is a block diagram illustrating a relationship between a tuner and a liquid crystal display device in the television receiver illustrated in FIG. 21.

FIG. 23 is an exploded perspective view of the television receiver illustrated in FIG. 21.

### BEST MODE FOR CARRYING OUT THE INVENTION

One of the embodiments of the present invention is described below with reference to the drawings.

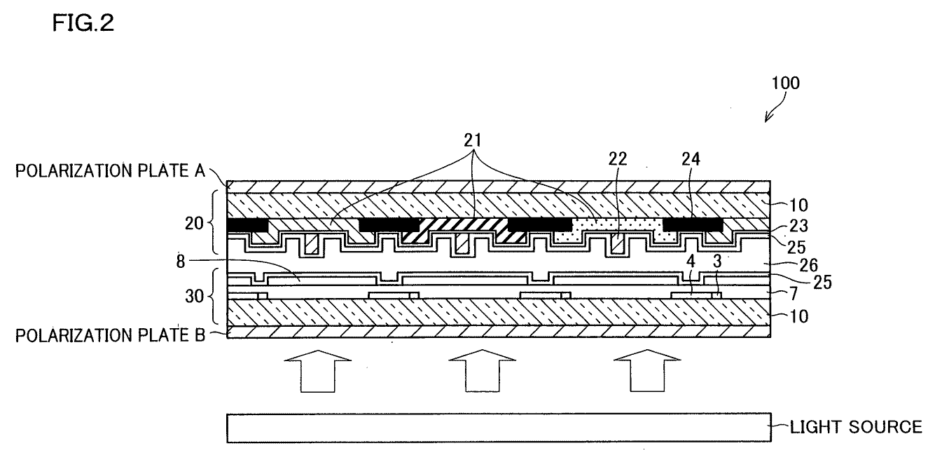

A general liquid crystal display device is, as shown in FIG. 2, arranged such that a polarization plate A and a polarization plate B are attached to a liquid crystal panel including a color filter and a drive substrate. An MVA (Multidomain Vertical Alignment) method is described here.

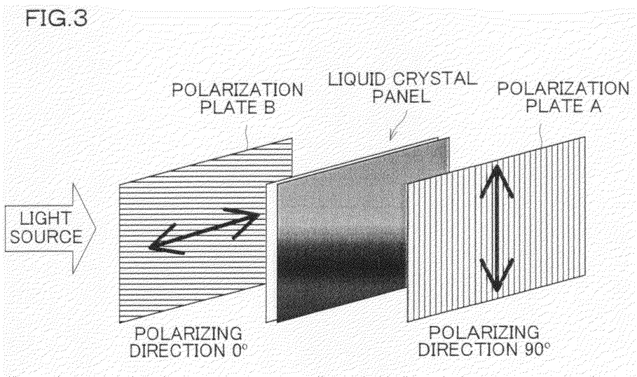

As shown in FIG. 3, a polarization axis of the polarization plate A is perpendicular to a polarization axis of the polarization plate B. When voltage at a threshold value is applied to a pixel electrode 8, the direction of a liquid crystal orientation is tilted to be at an azimuth angle of 45 degrees to the polarization axes of the polarization plates A and B. After polarized incident light goes through the polarization plate A, the polarized incident light goes through a liquid crystal layer. At this time, the polarization axis is rotated, and thereby the light is emitted from the polarization plate B. Also, when voltage at a threshold value or less is applied to the pixel electrode, the direction of the liquid crystal orientation is perpendicular to a substrate. Therefore, a polarization angle of the polarized incident light does not change, and this leads to black display. In the MVA method, four domains are provided in which liquid crystal is tilted in different directions when voltage is applied thereon (Multidomain). This provides a wide viewing angle.

In the arrangement using two polarization plates, however, there has been a limit to an improvement in contrast. In view of this, the inventors of the present invention found that shutter performance was improved both in a view from the front and in a view from an oblique angle when three polarization plates were used for two liquid crystal display panels and the three polarization plates were arranged in a crossed Nicols state with each other.

The principle of the improvement in contrast is specifically described below:

(1) Regarding a View from the Front

Leakage light occurs in the direction of a transmission axis under a crossed Nicols state because of depolarization in a panel (scattering in a CF or the like). However, the foregoing arrangement using three polarization plates makes it possible to shut off the leakage light by causing an absorbing axis of a third polarization plate to be directionally identical with the leakage light occurring in the direction of a transmission axis of a second polarization plate.

(2) Regarding a View from an Oblique Angle

Even when a Nicol angle φ of polarization plates is broken, the amount of leakage light does not change so much. That is, when a Nicol angle φ becomes large at an oblique viewing angle, black is less apt to be grayish.

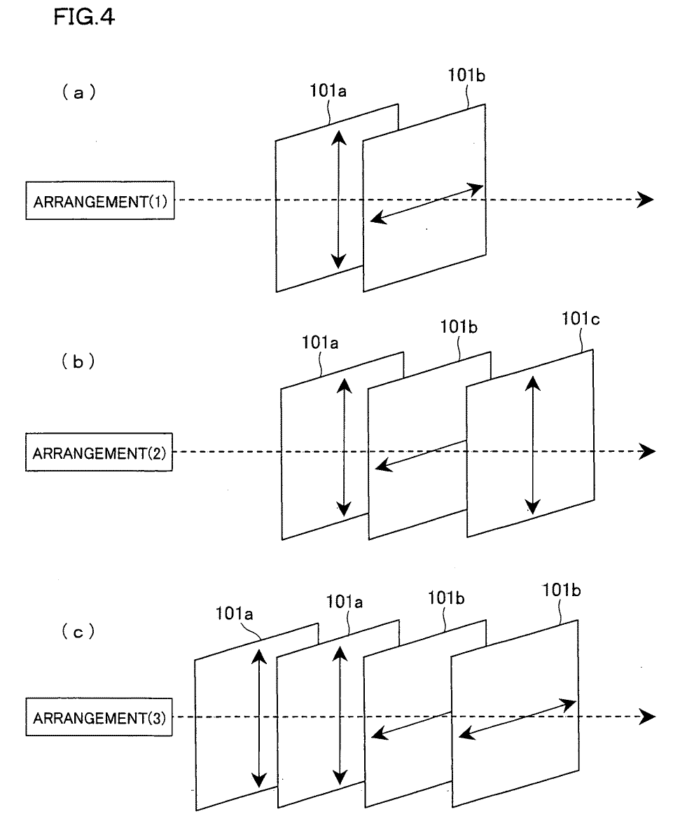

The inventors of the present invention found that the foregoing facts largely improved contrast in a liquid crystal display device. The principle of the improvement in contrast is described with reference to FIGS. 4 through 10 and Table 1. Here, an arrangement using two polarization plates is referred to as Arrangement (1), and an arrangement using three polarization plates is referred to as Arrangement (2). Here, the principle of the improvement in contrast in a view from an oblique angle is described schematically. In addition, the description deals with polarization plates only, and does not deal with a liquid crystal panel. This is because the improvement in contrast in a view from an oblique angle is substantially associated with the arrangement of polarization plates.

FIG. 4 (a) assumes a case where one liquid crystal display panel exists in Arrangement (1), and illustrates an example in which two polarization plates 101a and 101b are arranged in a crossed Nicols state. FIG. 4 (b) is a view illustrating an example in which three polarization plates 101a, 101b, and 101c are arranged in a crossed Nicols state with each other in Arrangement (2). That is, Arrangement (2) assumes a case where two liquid crystal display panels exist. This means that Arrangement (2) has two pairs of polarization plates arranged in a crossed Nicols state. FIG. 4 (c) is a view illustrating an example in which a polarization plate 101a is opposed to a polarization plate 101b, and the polarization plate 101a and the polarization plate 101b are arranged in a crossed Nicols state. In addition, in the example illustrated in FIG. 4 (c), an outer side of the polarization plate 101a is overlapped with another polarization plate 101a having the same polarizing direction, and an outer side of the polarization plate 101b is overlapped with another polarization plate 101b having the same polarizing direction. Although FIG. 4 (c) shows the arrangement having the four polarization plates, only one pair of the polarization plates which are assumed to sandwich one liquid crystal display panel therebetween are arranged in a crossed Nicols state.

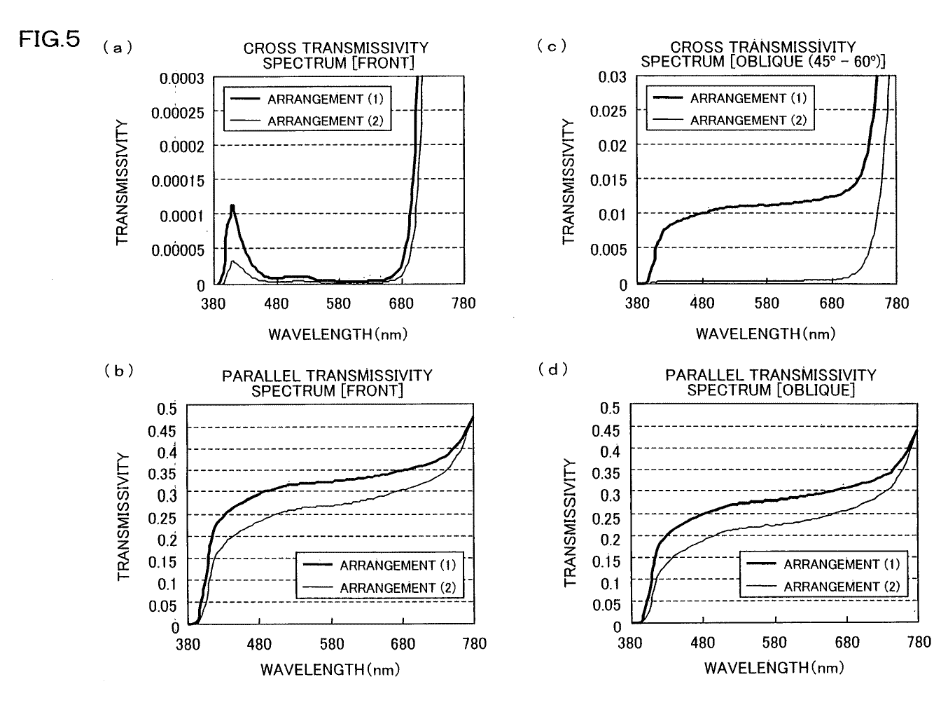

Transmissivity which is observed when a liquid crystal display panel carries out black display is modeled as “cross transmissivity” (i.e., transmissivity which is observed when no liquid crystal panel exists and polarization plates are arranged in a crossed Nicols state). The cross transmissivity is referred to as “black display”. Also, transmissivity which is observed when a liquid crystal display panel carries out white display is modeled as “parallel transmissivity” (i.e., transmissivity which is observed when no liquid crystal panel exists and polarization plates are arranged in a parallel Nicols state). The parallel transmissivity is referred to as “white display”. Here, the graphs shown in FIG. 5 (a) through FIG. 5 (d) illustrate the examples of: (i) a relationship between a wavelength of a transmission spectrum and transmissivity in a view from the front of a polarization plate; and (ii) a relationship between a wavelength of a transmission spectrum and transmissivity in a view from an oblique angle to a polarization plate. The foregoing two kinds of transmissivity thus modeled are an ideal transmissivity value for white display and black display in a method where polarization plates are arranged in a crossed Nicols state and sandwiches a liquid crystal panel therebetween.

FIG. 5 (a) is a graph comparing Arrangement (1) and Arrangement (2) in a relationship between a wavelength of a transmission spectrum and cross transmissivity in a view from the front of a polarization plate. This graph shows that Arrangement (1) and Arrangement (2) have a similar tendency in a transmissivity characteristic in a view from the front during black display.

FIG. 5 (b) is a graph comparing Arrangement (1) and Arrangement (2) in a relationship between a wavelength of a transmission spectrum and parallel transmissivity in a view from the front of a polarization plate. This graph shows that Arrangement (1) and Arrangement (2) have a similar tendency in a transmissivity characteristic in a view from the front during white display.

FIG. 5 (c) is a graph comparing Arrangement (1) and Arrangement (2) in a relationship between a wavelength of a transmission spectrum and cross transmissivity in a view from an oblique angle (i.e., an azimuth angle of 45 degrees and a polar angle of 60 degrees) of a polarization plate. This graph shows the following transmissivity characteristic in a view from an oblique angle during black display: Arrangement (2) has a transmissivity value of nearly 0 in an almost entire wavelength range; and Arrangement (1) has a little amount of light transmissivity in an almost entire wavelength range. That is, in an arrangement having two polarization plates, leakage light (i.e., deterioration in sharpness of black) occurs at an oblique viewing angle during black display. On the other hand, in an arrangement having three polarization plates, the amount of leakage light (i.e., deterioration in sharpness of black) is minimized at an oblique viewing angle during black display.

FIG. 5 (d) is a graph comparing Arrangement (1) and Arrangement (2) in a relationship between a wavelength of a transmission spectrum and parallel transmissivity in a view from an oblique angle (i.e., an azimuth angle of 45 degrees and a polar angle of 60 degrees) of a polarization plate. This graph shows that Arrangement (1) and Arrangement (2) have a similar tendency in a transmissivity characteristic in a view from an oblique angle during white display.

Thus, during white display, as shown in FIG. 5 (b) and FIG. 5 (d), there is less difference caused by the number of polarization plates, that is to say, the number of pairs of polarization plates arranged in a crossed Nicols state. In addition, almost the same transmissivity characteristic is observed both in a view from the front and in a view from an oblique angle.

However, during black display, as shown in FIG. 5 (c), deterioration in sharpness of black at an oblique viewing angle occurs in Arrangement (1) having one pair of polarization plates which are arranged in a crossed Nicols state. On the other hand, deterioration in sharpness of black at an oblique viewing angle is minimized in Arrangement (2) having two pairs of polarization plates which are arranged in a crossed Nicols state.

For example, Table 1 below shows (i) transmissivity in a view from the front and (ii) transmissivity in a view from an oblique angle when a wavelength of transmission spectrum is 550 nm.

TABLE 1

| | Front | | | Oblique (45°-60°) | | |
|---|---|---|---|---|---|---|
| | ARR (1) | ARR (2) | (2)/(1) | ARR (1) | ARR (2) | (2)/(1) |
| Parallel | 0.319 | 0.265 | 0.832 | 0.274499 | 0.219084 | 0.798 |
| Cross | 0.000005 | 0.000002 | 0.4 | 0.01105 | 0.000398 | 0.0360 |
| Parallel/Cross | 63782 | 132645 | 2.1 | 24.8 | 550.5 | 22.2 |

Abbreviation:
ARR (1) stands for Arrangement (1).
ARR (2) stands for Arrangement (2).

In Table 1, “parallel” indicates “parallel transmissivity” which means transmissivity during white display, and “cross” indicates “cross transmissivity” which means transmissivity during black display. Therefore, “parallel/cross” means contrast.

According to Table 1, in a view from the front, Arrangement (2) has approximately twice as higher contrast as Arrangement (1) has. Further, in a view from an oblique angle, Arrangement (2) has approximately 22 times as higher contrast as Arrangement (1) has. Thus, Arrangement (2) significantly improves contrast in a view from an oblique angle.

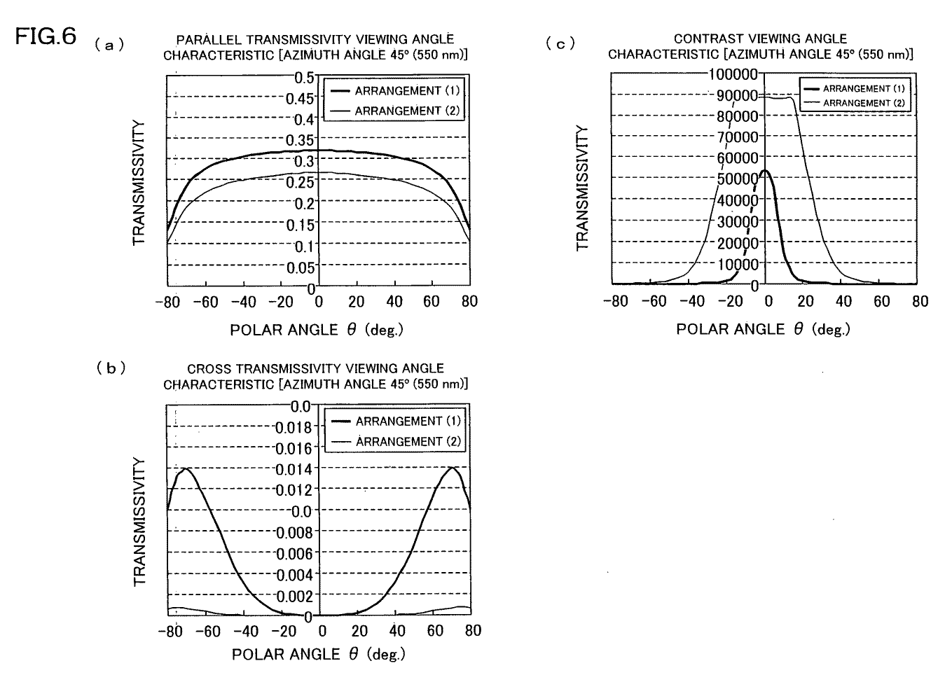

The following description deals with a viewing angle characteristic during white display and black display with reference to FIG. 6 (a) through FIG. 6 (c). Here, the following case is described: (i) an azimuth angle to a polarization plate is 45 degrees and (ii) a wavelength of a transmission spectrum is 550 nm.

FIG. 6 (a) is a graph illustrating a relationship between a polar angle and transmissivity during white display. This graph shows that Arrangement (2) and Arrangement (1) have a similar tendency in a viewing angle characteristic (i.e., a parallel viewing angle characteristic) in this case, although Arrangement (2) has lower transmissivity than Arrangement (1) in an almost entire range.

FIG. 6 (b) is a graph illustrating a relationship between a polar angle and transmissivity during black display. This graph shows that: Arrangement (2) has transmissivity which is minimized at an oblique viewing angle (i.e., around polar angle ±80 degrees); and Arrangement (1) has transmissivity which is increased at an oblique viewing angle. That is, deterioration in sharpness of black at an oblique viewing angle is more remarkable in Arrangement (1), compared to in Arrangement (2).

FIG. 6 (c) is a graph illustrating a relationship between a polar angle and contrast. This graph shows that Arrangement (2) has far better contrast than Arrangement (1). In FIG. 6 (c), the line of Arrangement (2) is flat in the vicinity of 0 degree. This is because that transmissivity for black is so low that a calculation cannot be carried out without smaller digits. Actually, the line should be a smooth curve line.

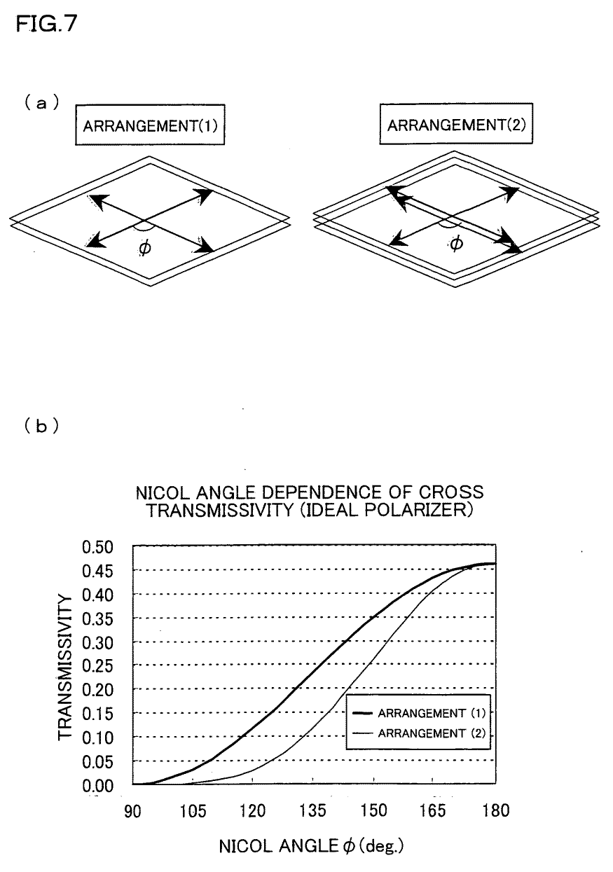

Next, with reference to FIGS. 7 (a) and (b), the following description deals with that the amount of leakage light does not change so much even when a Nicol angle φ of polarization plates is broken; that is, deterioration in sharpness of black rarely occurs even when a Nicol angle φ becomes large at an oblique viewing angle. A Nicol angle φ of polarization plates here means, as shown in FIG. 7 (a), an angle created by an arrangement in which a polarization axis of one polarization plate and a polarization axis of the other polarization plate are in a twisted state, the polarization plates being opposed to each other. FIG. 7 (a) is a perspective view in which polarization plates are arranged in a crossed Nicols state. Also, in FIG. 7 (a), a Nicol angle φ has been changed from 90 degrees (i.e., the Nicol angle is broken).

FIG. 7 (b) is a graph illustrating a relationship between a Nicol angle φ and cross transmissivity. This graph uses, for the calculation, an ideal polarizer (parallel Nicol transmissivity of 50% and crossed Nicol transmissivity of 0%). This graph shows that Arrangement (2) has less amount of change in transmissivity in response to a change in a Nicol angle φ during black display, compared to Arrangement (1). That is, an arrangement having three polarization plates is less apt to be affected by a change in a Nicol angle φ than an arrangement having two polarization plates.

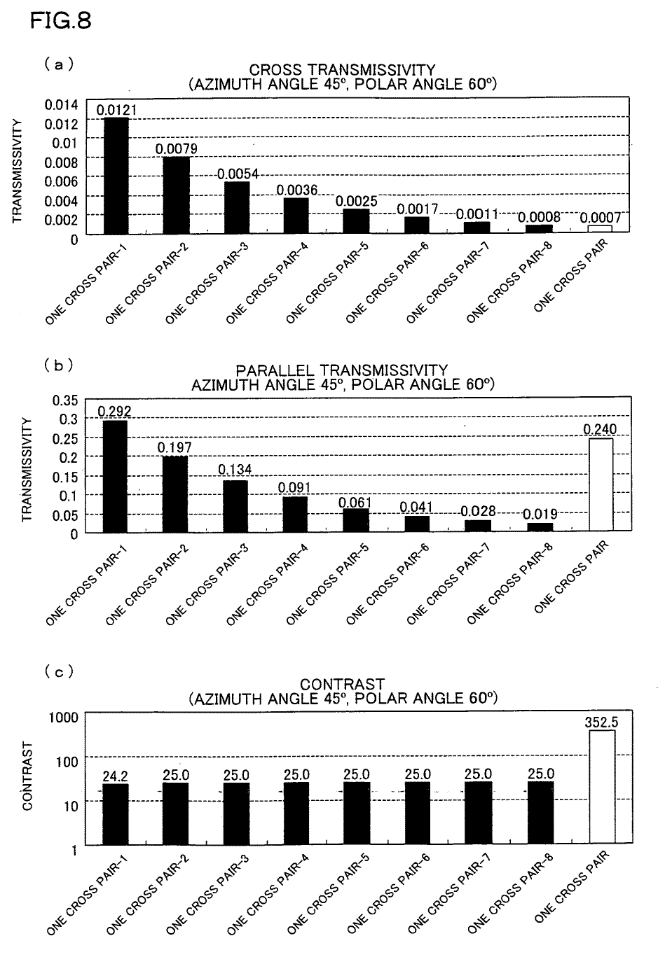

Next, with reference to FIG. 8 (a) through FIG. 8 (c), the following description deals with polarization plate thickness dependence. A thickness of a polarization plate is adjusted by having Arrangement (3) here. Specifically, as shown in FIG. 4 (c), one pair of polarization plates are arranged in a crossed Nicols state, and each of the polarization plates is overlapped with another polarization plate having the same polarization axis. FIG. 4 (c) shows an example in which one pair of the polarization plates 101a and 101b are arranged in a crossed Nicols state, the polarization plate 101a is overlapped with another polarization plate 101a, and the polarization plate 101b is overlapped with another polarization plate 101b. In this example, the polarization plate 101a and the another polarization plate 101a have a polarization axis of the same polarizing direction, and the polarization plate 101b and the another polarization plate 101b have a polarization axis of the same polarizing direction. The arrangement of this example has another two polarization plates, in addition to two polarization plates which make a pair and are arranged in a crossed Nicols state. Therefore, this arrangement is denoted as “one cross pair-2”. When the number of polarization plates being overlapped to the pair of polarization plates increases, the arrangement will be denoted as “one cross pair-3”, “one cross pair-4”, and the like, in accordance with the number of polarization plates.

FIG. 8 (a) is a graph illustrating a relationship between a thickness of a pair of polarization plates being arranged in a crossed Nicols state and transmissivity (cross transmissivity) during black display. This graph also shows transmissivity of an arrangement having two pairs of polarization plates being arranged in a crossed Nicols state for the purpose of a comparison between the two arrangements.

FIG. 8 (b) is a graph illustrating a relationship between a thickness of a pair of polarization plates being arranged in a crossed Nicols state and transmissivity (parallel transmissivity) during white display. This graph also shows transmissivity of an arrangement having two pairs of polarization plates being arranged in a crossed Nicols state for the purpose of a comparison between the two arrangements.

The graph in FIG. 8 (a) shows that transmissivity during black display becomes lower as the number of polarization plates being overlapped increases. However, the graph in FIG. 8 (b) shows that transmissivity during white display also becomes lower as the number of polarization plates being overlapped increases. That is, when more and more polarization plates are overlapped for the purpose of minimizing deterioration in sharpness of black during black display, a reduction in transmissivity occurs during white display.

FIG. 8 (c) shows a graph illustrating a relationship between a thickness of a pair of polarization plates being arranged in a crossed Nicols state and contrast. This graph also shows contrast in an arrangement having two pairs of polarization plates being arranged in a crossed Nicols state for the purpose of a comparison between the two arrangements.

As described above, the graphs in FIG. 8 (a) through FIG. 8 (c) show that an arrangement having two pairs of polarization plates being arranged in a crossed Nicols state is capable of (i) minimizing deterioration in sharpness of black during black display and (ii) avoiding an reduction in transmissivity during white display. Furthermore, the two pairs of polarization plates being arranged in a crossed Nicols state have a total of three polarization plates. Therefore, this arrangement does not increase the thickness of the entire liquid crystal display device. In addition, this arrangement improves contrast significantly.

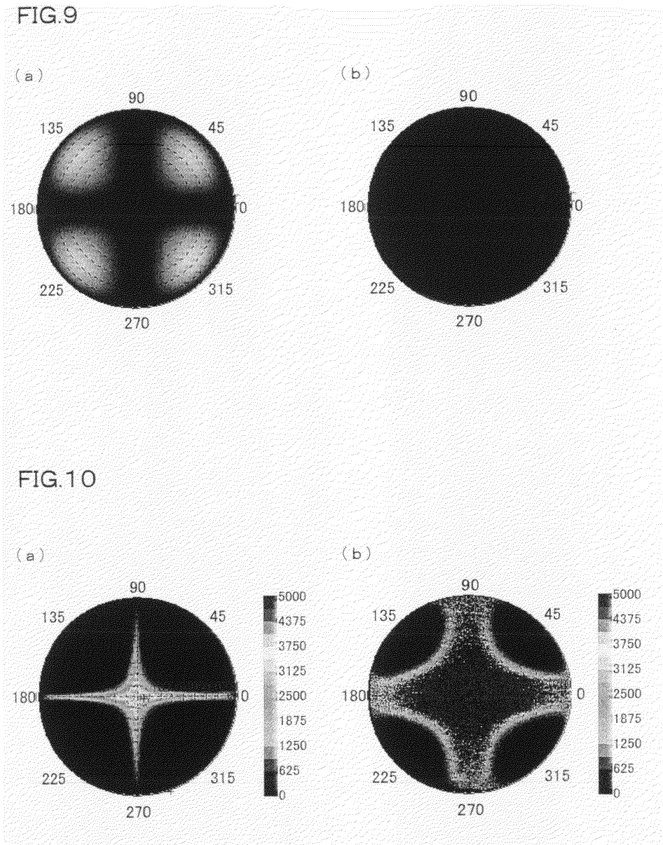

FIGS. 9 (a) and (b) show a viewing angle characteristic of crossed Nicols transmissivity specifically. FIG. 9 (a) is a view illustrating a crossed Nicols viewing angle characteristic in Arrangement (1), that is, an arrangement having two polarization plates which make a pair and are arranged in a crossed Nicols state. FIG. 9 (b) is a view illustrating a crossed Nicols viewing angle characteristic of Arrangement (2), that is, an arrangement having three polarization plates which make two pairs and are arranged in a crossed Nicols state.

FIGS. 9 (a) and (b) show that deterioration in sharpness of black (which corresponds to an increase in transmissivity during black display) rarely occurs in an arrangement having two pairs of polarization plates in a crossed Nicols state. (This is outstanding in the directions of 45°, 135°, 225°, and 315°.)

FIGS. 10 (a) and (b) show a contrast viewing angle characteristic (i.e., parallel/cross brightness) specifically. FIG. 10 (a) is a view illustrating a contrast viewing angle characteristic in Arrangement (1), that is, an arrangement having two polarization plates which make a pair and are arranged in a crossed Nicols state. FIG. 10 (b) is a view illustrating a contrast viewing angle characteristic in Arrangement (2), that is, an arrangement having three polarization plates which make two pairs and are arranged in a crossed Nicols state.

FIGS. 10 (a) and (b) show that an arrangement having two pairs of polarization plates in a crossed Nicols state has contrast which is more improved, compared to an arrangement having one pair of polarization plates in a crossed Nicols state.

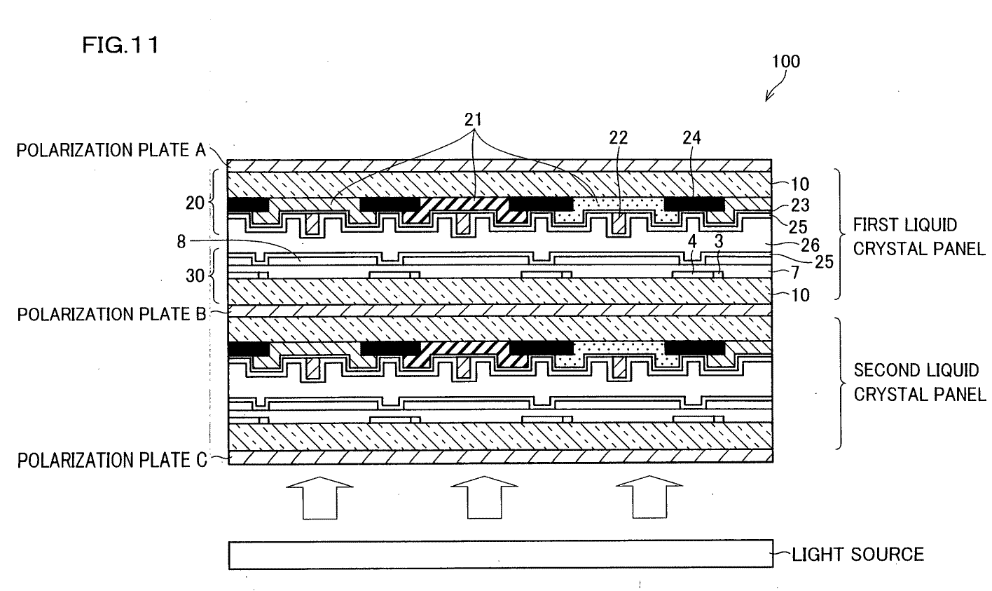

The following description deals with a liquid crystal display device using the foregoing principle of an improvement in contrast with reference to FIG. 2, FIG. 3, and FIGS. 11 through 17.

FIG. 11 is a schematic cross-sectional view of a liquid crystal display device 100 in accordance with the present embodiment.

The liquid crystal display device 100 is, as shown in FIG. 11, arranged such that first and second panels are alternately overlapped with polarization plates A, B, and C.

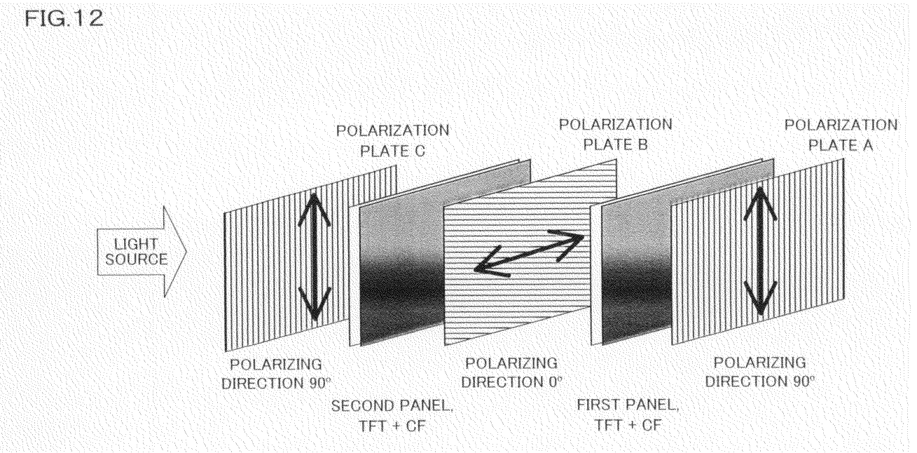

FIG. 12 is a view illustrating an arrangement of polarization plates and liquid crystal panels in the liquid crystal display device 100 of FIG. 11. In FIG. 12, a polarization axis of a polarization plate A is perpendicular to a polarization axis of a polarization plate B, and the polarization axis of the polarization plate B is perpendicular to a polarization axis of a polarization plate C. That is, the polarization plates A and B are arranged in a crossed Nicols state, and the polarization plates B and C are arranged in a crossed Nicols state.

Each of the first panel and the second panel includes one pair of transparent substrates (i.e., a color filter substrate 20 and an active matrix substrate 30), and liquid crystal is sealed between the transparent substrates. The first panel and the second panel has means for switching between: (i) a state where polarized incident light coming from a light source to the polarization plate A is rotated by approximately 90 degrees; (ii) a state where polarized light is not rotated; and (iii) a state midway between the state (i) and the state (ii). This means is carried out by electrically changing a liquid crystal orientation, depending on the purpose.

In addition, each of the first panel and the second panel includes a color filter and a function for displaying an image by using a plurality of pixels. Examples of the display method having such a function encompass a TN (Twisted Nematic) method, a VA (Vertical Alignment) method, an IPS (In Plain Switching) method, an FFS (Fringe Field Switching) method, and a method given by a combination of the foregoing methods. Especially, the VA method is suitable because the VA method has high contrast even when the VA method is used alone and is not combined with any other methods. Therefore, the description given here deals with a case in which an MVA (Multidomain Vertical Alignment) method is used. Note that the IPS method and the FFS method are sufficiently effective because the IPS method and the FFS method also employ a normally black method. The drive method adopts an active matrix drive using a TFT (Thin Film Transistor). The detail about a manufacturing method of the MVA is disclosed in Japanese Unexamined Patent Application Publication, Tokukai, 2001-83523 and other materials.

The first panel and the second panel in the liquid crystal display device 100 have the same arrangement. Specifically, each of the first and second panels is, as described above, arranged such that: the color filter substrate 20 is opposed to the active matrix substrate 30; and a plastic bead and a resin column (formed on the color filter substrate 20 and the like) are used as a spacer (not illustrated) so as to maintain a certain interval between the substrates. Liquid crystal is sealed between a pair of substrates (i.e., the color filter substrate 20 and the active matrix substrate 30), and each surface (which contacts the liquid crystal) of the substrates has a vertical alignment film 25. For the liquid crystal, nematic liquid crystal having negative dielectric anisotropy is used.

The color filter substrate 20 is a transparent substrate 10 on which a color filter 21, a black matrix 24, and the like are formed.

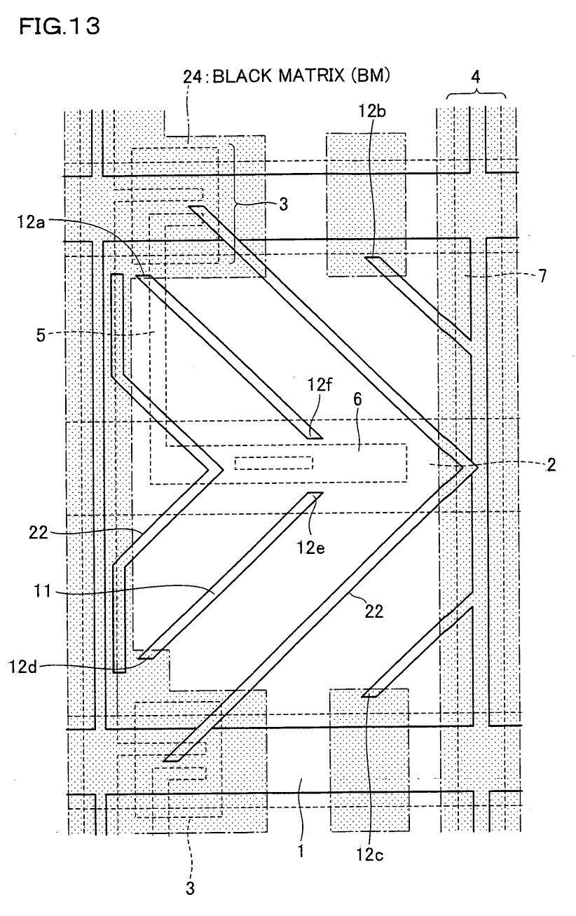

As shown in FIG. 13, the active matrix substrate 30 is a transparent substrate 10 on which a TFT element 3, a pixel electrode 8, and the like are formed, the transparent substrate 10 further including a projection 22 and a slit pattern 11, each of which is used for alignment control for determining an alignment direction of liquid crystal. When voltage at a threshold value or more is applied to the pixel electrode 8, liquid crystal molecules are tilted along a direction perpendicular to the projection 22 and the slit pattern 11. In the present embodiment, the projection 22 and the slit pattern 11 are formed so that the liquid crystal molecules are tilted along the direction of an azimuth angle of 45 degrees to the polarization axis of the polarization plate.

As described above, the first panel and the second panel are arranged so that each position of a red pixel (R), a green pixel (G), and a blue pixel (B) on the color filter 21 of the first panel corresponds to each position of a red pixel (R), a green pixel (G), and a blue pixel (B) on the color filter 21 of the second panel, respectively, in a view from a perpendicular direction. Specifically, the position of the R pixel on the first panel corresponds to the position of the R pixel on the second panel; the position of the G pixel on the first panel corresponds to the position of the G pixel on the second panel; and the position of the B pixel on the first panel corresponds to the position of the B pixel on the second panel, in a view from a perpendicular direction.

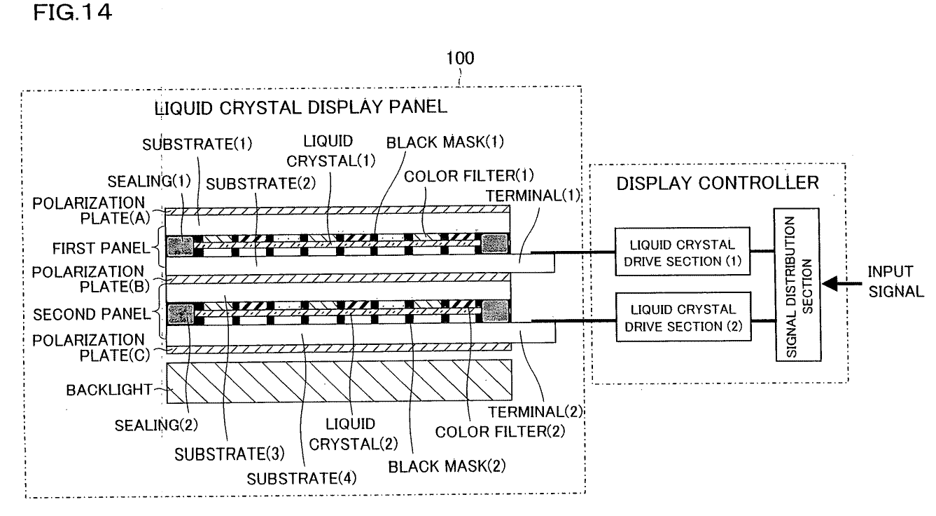

FIG. 14 schematically illustrates a drive system for the liquid crystal display device 100 having the foregoing arrangement.

The drive system includes a display controller required for displaying an image on the liquid crystal display device 100.

The display controller includes: a first panel drive circuit (1) which drives the first panel by using a predetermined signal; and a second panel drive circuit (2) which drives the second panel by using a predetermined signal. The display controller further includes a signal distribution circuit section for distributing an image source signal to the first and second panel drive circuits (1) and (2).

That is, the display controller is arranged such that a signal is transmitted to the panels so as to allow the liquid crystal display device 100 to display an appropriate image.

The display controller is a device for transmitting an appropriate electric signal to the panel in accordance with an image signal which is supplied, and includes a driver, a circuit board, a panel drive circuit, and the like.

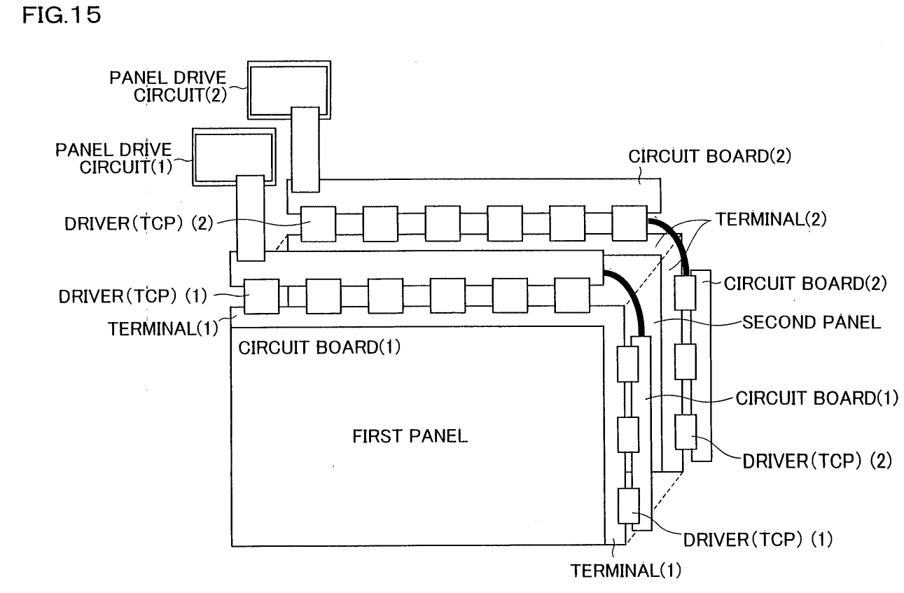

FIG. 15 illustrates a connection between the first panel and the first panel drive circuit, and a connection between the second panel and the second panel drive circuit. A polarization plate is not illustrated in FIG. 15.

The first panel drive circuit (1) is connected via a driver (TCP) (1) to a terminal (1) provided on a circuit board (1) on the first panel. That is, the first panel is connected to the driver (TCP) (1), and is connected to the panel drive circuit (1) via the circuit board (1).

A connection between the second panel and the second panel drive circuit (2) is made in the same way as the connection between the first panel and the first panel drive circuit (1). Therefore, the description of the connection for the second panel is omitted.

Next, the following description deals with operation of the liquid crystal display device 100 having the foregoing arrangement.

A pixel on the first panel is driven in accordance with a display signal. Then, on the second panel, a pixel whose position corresponds to the position of the pixel on the first panel in a view from a direction perpendicular to the panel is driven in accordance with the corresponding pixel on the first panel. Specifically, when a section referred to as Arrangement Section 1 includes the polarization plate A, the first panel, and the polarization plate B; and a section referred to as Arrangement Section 2 includes the polarization plate B, the second panel, and the polarization plate C, the driving process is carried out as follows. When Arrangement Section 1 is under a transmissive state, Arrangement Section 2 is also under a transmissive state. Similarly, when Arrangement Section 1 is under a non-transmissive state, Arrangement Section 2 is also under a non-transmissive state.

Here, the following description deals with manufacturing methods of the active matrix substrate 30 and the color filter substrate 20.

Firstly, the manufacturing method of the active matrix substrate 30 is described.

As shown in FIG. 13, firstly, a scanning signal wiring (i.e., a gate wiring or a gate bus wiring) 1 and an auxiliary capacitor wiring 2 are formed on the transparent substrate 10 by the following processes: (i) a metal film such as a laminated film of Ti/Al/Ti is formed by sputtering; (ii) a resist pattern is formed by using a photolithography method; (iii) dry-etching is carried out by using etching-gas such as chlorine gas; and (iv) resist removal is performed. By carrying out these processes, the scanning signal wiring 1 and the auxiliary capacitor wiring 2 are formed on the transparent substrate 10 simultaneously.

After the foregoing processes are carried out, the following layers are formed through a CVD (Chemical Vapor Deposition): a gate insulation layer formed from silicon nitride (SiNx) and the like; an active semiconductor layer formed from amorphous silicon and the like; and a low resistance semiconductor layer formed from amorphous silicon doped with phosphorous and the like. Then, a data signal wiring (i.e., a source wiring or a source bus wiring) 4, a drain drawing wiring 5, and an auxiliary capacitor forming electrode 6 are formed by the following processes: (i) a metal film of Al/Ti or the like is formed by the sputtering; (ii) a resist pattern is formed by using a photolithography method; (iii) dry-etching is carried out by using etching gas such as chlorine gas and the like; and (iv) the resist is removed. By carrying out these processes, the data signal wiring 4, the drain drawing wiring 5, and the auxiliary capacitor forming electrode 6 are formed simultaneously.

The auxiliary capacitor is formed by sandwiching a gate insulating film of approximately 4000 Å between the auxiliary capacitor wiring 2 and the auxiliary capacitor forming electrode 6.

Subsequently, the low resistance semiconductor layer is subjected to dry-etching by using chlorine gas or the like for the purpose of a source-drain separation. As a result, a TFT element 3 is formed.

Next, an interlayer insulating film 7 made from an acrylic photosensitive resin and the like is applied by spin-coating. Then, a contact hole (not illustrated) for causing the drain drawing wiring 5 to electrically contact the pixel electrode 8 is formed by using the photolithography method. The thickness of the interlayer insulating film 7 is approximately 3 μm.

After that, the pixel electrode 8 is formed, and then a vertical alignment film (not illustrated) is formed.

The present embodiment is, as described above, related to an MVA liquid crystal display device. In the embodiment, the slit pattern 11 is provided on the pixel electrode 8 formed from ITO or the like. Specifically, a pixel electrode pattern as illustrated in FIG. 13 is obtained by carrying out the following processes: (i) a layer is formed by the sputtering; (ii) a resist pattern is formed by using the photolithography method; and (iii) etching is carried out by using an etching solution such as ferric chloride.

Through the foregoing processes, the active matrix substrate 30 is obtained.

The reference numerals 12a, 12b, 12c, 12d, 12e, and 12f in FIG. 13 indicate slits formed on the pixel electrode 8. At an electrical connection on these slits, disorder of an orientation of liquid crystal occurs, thereby causing an alignment abnormality. Note in the slits 12a through 12d that the duration of an application of negative electrical potential becomes dominant, in addition to the occurrence of the alignment abnormality. This is because voltage supplied to the gate wiring has the following characteristics: a μ-second order is normally used for the duration of an application of positive electrical potential which is supplied so as to turn the TFT element 3 on; and an m-second order is normally used for the duration of an application of negative electrical potential which is supplied so as to turn the TFT element 3 off. Therefore, when the slits 12a through 12d are positioned on the gate wiring, the slits 12a through 12d will gather ionic impurities contained in the liquid crystal because of an applied negative gate DC component. This gathering of the ionic impurities can be visually recognized as a display irregularity. For the foregoing reasons, the slits 12a through 12d should be provided in a region which does not overlap with the gate wiring when viewed in a plane. It is desirable for the slits 12a through 12d to be covered by a black matrix 24 as shown in FIG. 13.

Next, the following description deals with a manufacturing method of the color filter substrate 20.

The color filter substrate 20 includes the followings on the transparent substrate 10: a color filter layer having the color filter 21 of three primary colors (i.e., red, green, and blue), the black matrix (BM) 24, and the like; a counter electrode 23; a vertical alignment film 25; and a projection 22 for alignment control.

Firstly, a negative acrylic photosensitive resin solution in which fine particulates of carbon are dispersed is applied on the transparent substrate 10 by the spin-coating, and a drying process is carried out, so as to form a black photosensitive resin layer. Subsequently, the black photosensitive resin layer is exposed to light via a photo mask, and a development process is carried out, so as to form a black matrix (BM) 24. The BM is formed so that: an opening for a first colored layer (e.g., a red layer) is formed in a region where the first colored layer is to be formed; an opening for a second colored layer (e.g., a green layer) is formed in a region where the second colored layer is to be formed; and an opening for a third colored layer (e.g., a blue layer) is formed in a region where the third colored layer is to be formed. At this time, each of the openings corresponds to a certain pixel electrode, respectively. More specifically, as illustrated in FIG. 13, a BM pattern is formed in an isolated shape, so as to shield light from the alignment abnormality region which occurs at an electrical connection of the slits 12a through 12d out of the slits 12a through 12f formed on the pixel electrode 8. Also, a light-shielding section (i.e., a BM) is formed on the TFT element 3 so as to prevent an increase in the amount of a leak current which is due to light excitation by incidence of external light toward the TFT element 3.

Next, a negative acrylic photosensitive resin solution in which pigments are dispersed is applied by the spin-coating. Then, a drying process, an exposure process using a photo mask, and a development process are subsequently carried out, so as to form a red layer.

Then, the same process is respectively carried out for the second color layer (e.g., a green layer) and the third color layer (e.g., a blue layer). As a result, a color filter 21 is formed.

After that, a counter electrode 23 formed from a transparent electrode such as ITO is formed by the sputtering. Then, a positive Phenol Novolac photosensitive resin solution is applied by the spin-coating. A drying process, an exposure process using a photo mask, and a developing process are subsequently carried out, so as to form a projection 22 for vertical alignment control.

The color filter substrate 20 is formed through the foregoing processes.

In the present embodiment, a BM made of resin is described. However, the BM may be made of metal. Also, the colored layers of three primary colors are not limited to red, green, and blue, but may encompass the colored layers of cyan, magenta, yellow, or other colors. In addition, the colored layer of white may be included.

The following describes a manufacturing method of a liquid crystal panel (i.e., a first panel and a second panel) by using the color filter substrate 20 and the active matrix substrate 30 which are manufactured in the foregoing processes.

Firstly, the vertical alignment film 25 is formed on each surface of the color filter substrate 20 and the active matrix substrate 30, the surface to which the vertical alignment film 25 is formed coming in contact with liquid crystal. Specifically, before an alignment film is formed by application on the substrate, a baking process is carried out for the purpose of degasification. Then, the substrate is cleaned, and an alignment film is formed by application on the substrate. After that, a baking process for the alignment film is carried out. Subsequently, an alignment film is formed by application on the substrate, and the substrate is cleaned. Further, a baking process is carried out for the purpose of degasification. The vertical alignment film 25 defines a direction of an orientation of the liquid crystal 26.

Next, the following description deals with a method for sealing liquid crystal between the active matrix substrate 30 and the color filter substrate 20.

Liquid crystal may be introduced, for example, through a vacuum filling method or the like. The vacuum filling method is carried out as follows: (i) thermosetting sealing resin is applied to the periphery of the substrates, except for a filling hole, through which liquid crystal is introduced; (ii) the filling hole is soaked in the liquid crystal in a vacuum; (iii) the pressure is released to an atmospheric pressure, so as to introduce the liquid crystal; and (iv) the filling hole is sealed off with UV cure resin or the like. The vacuum filling method, however, has a drawback that time required for a liquid crystal panel having a vertical alignment to fill liquid crystal in is much longer than time required for a liquid crystal panel having a horizontal alignment. Therefore, the description here deals with a one-drop-fill method.

UV cure sealing resin is applied to the periphery of the active matrix substrate, and liquid crystal is dripped onto a color filter substrate by using the one-drop-fill method. Through the one-drop-fill method, an optimum amount of the liquid crystal is regularly dripped to the inside of the sealing so that the liquid crystal creates a desired cell gap.

As described above, the color filter substrate (which has been subjected to the dripping of the liquid crystal) is bonded with the active matrix substrate (which has been subjected to the seal patterning) by the following processes: (i) the pressure inside a bonding machine is reduced to 1 Pa; (ii) under the reduced pressure, the active matrix substrate and the color filter substrate are overlapped; and (iii) the pressure is returned to an atmospheric pressure, so as to compress the sealing part. As a result, a desired gap in the sealing part can be obtained.

After the assembly obtains the desired cell gap in the sealing part, the assembly is subjected to UV irradiation by using a UV-curing device, so as to pre-cure the sealing resin. Further, a baking process is carried out for the purpose of a final-curing of the sealing resin. At this point, the liquid crystal has spread over the inside of the sealing resin, and the state where the cell is filled with the liquid crystal is obtained. When the baking process is completed, the assembly is divided so as to make pieces of liquid crystal panel. Thus, a liquid crystal panel is completed.

In the present embodiment, the first panel and the second panel are manufactured through the same process.

The following description deals with a mounting method of the first panel and the second panel each of which is manufactured through the foregoing process.

After the first panel and the second panel are cleaned, a polarization plate is attached to each of the first panel and the second panel. Specifically, as shown in FIG. 14, a polarization plate A is attached to the top surface of the first panel, a polarization plate B is attached to the back surface of the first panel, and a polarization plate C is attached to the back surface of the second panel. The polarization plates may be overlapped with an optical compensation sheet or the like, as needed.

Next, a driver (i.e., an LSI for driving liquid crystal) is connected. A connection method for the driver using a TCP (Tape Carrier Package) method is described here.

For example, as shown in FIG. 15, an ACF (Anisotropic Conductive Film) is pre-bonded to a terminal (1) of the first panel. Then, a TCP (1) on which a driver is placed is punched out from a carrier tape, and the TCP (1) is positioned to be connected with a panel terminal electrode. Subsequently, the ACF is thermally bonded. After that, a circuit board (1) for connecting the driver TCP (1) to another driver TCP (1) is connected to an input terminal (1) of the TCP (1) via the ACF.

Next, the two panels are bonded to each other. Each of the top and back surfaces of the polarization plate B is provided with an adhesive layer. The bonding process of the two panels is carried out such that (i) the surface of the second panel is cleaned, (ii) a laminate of the adhesive layer on the polarization plate B being attached to the first plate is removed, (iii) the first panel is aligned with the second panel precisely, (iv) and the first panel and the second panel are bonded to each other. It is desirable to bond the panels in a vacuum lest a void can remain between the panel and the adhesive layer through this process.

As another method of bonding the panels to each other, the following method is possible: (i) an adhesive (such as an epoxy adhesive) which cures at an ambient temperature or at a panel's upper temperature limit or less is applied to the periphery of the panel; (ii) plastic spacers are spread; and (iii) fluorine oil or the like is sealed in. It is preferable that the adhesive to be applied has: an optical isotropy; a similar refractive index to that of the glass substrate; and similar stability to that of the liquid crystal.

In the present embodiment, the foregoing mounting method may also be applied to a case where a surface having a terminal of a first panel is located at the same position as a surface having a terminal of a second panel as illustrated in FIG. 14 and FIG. 15. The direction of a terminal to a panel and a bonding method are not particularly limited. For example, the bonding method may be a method which holds panels mechanically and does not utilize adhesion.

Following the bonding process, a lighting device, which is called a backlight, is mounted. As a result, a liquid crystal display device 100 is completed.

The following description deals with one of the embodiments of a lighting device which is preferable for the present invention. The present invention is, however, not limited to the embodiment of the lighting device described below, but may be changed as needed.

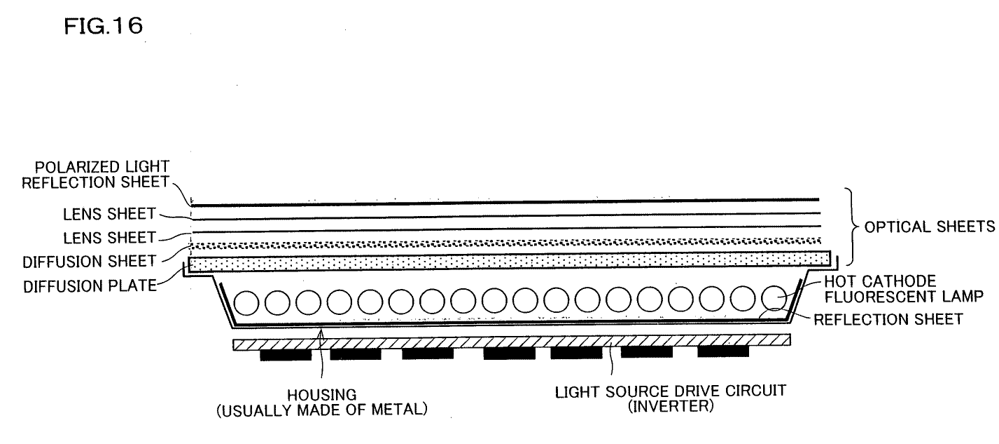

Because of its display principle, the liquid crystal display device 100 of the present invention needs a backlight which is capable of providing more amount of light compared to a backlight used for a conventional panel. In addition, the liquid crystal display device 100 of the present invention needs to use a blue light source having a shorter wavelength for the lighting device, because absorption of a short wavelength is especially remarkable in a wavelength region. FIG. 16 illustrates one of the examples of a lighting device which satisfies these conditions.

The liquid crystal display device 100 of the present invention here uses a hot cathode fluorescent lamp so as to achieve a similar brightness to that of the conventional liquid crystal display device. A hot cathode fluorescent lamp is capable of outputting approximately six times as much amount of light as a cold cathode fluorescent lamp which is conventionally used outputs.

A 37-inch diagonal WXGA display is described as an example of a standard liquid crystal display device. The 37-inch diagonal WXGA display has 18 lamps with an outer diameter of φ 15 mm, and the 18 lamps are set on a housing made of aluminum. A white reflection sheet using foamed resin is provided for the housing so as to effectively utilize light emitted from the lamps to the rear. A power source for actuating the lamps is located on the backside of the housing, and the lamps are actuated by electric power supplied from a household power source.

In a direct backlight in which the housing has the plurality of lamps, a translucent-white resin plate is necessary so as to make the images of the lamps invisible. In view of this, the housing is provided with, above the lamps, a plate which has a thickness of 2 mm and is mainly made from polycarbonate (the polycarbonate is hard to be bent after absorption of moisture, and is hard to be deformed by heat). In addition, optical sheets are placed on the plate so as to achieve a certain optical effect. In this arrangement, the optical sheets are layered as follows: a diffusion sheet; a lens sheet; a lens sheet; and a polarized light reflection sheet (in this order from the bottom). This arrangement makes it possible to obtain approximately ten times as much brightness of a backlight as that of a general arrangement including 18 cold cathode fluorescent lamps of φ 4 mm, two diffusion sheets, and a polarized light reflection sheet. As a result, the 37-inch liquid crystal display device of the present invention can obtain brightness of approximately 400 cd/m².

In this arrangement, the backside of a back chassis is provided with (i) a fin for facilitating heat discharge to atmosphere and (ii) a fan for forcibly stirring the air. This is because a heating value of the backlight of the present embodiment is approximately five times as higher as that of a conventional backlight.

The mechanical members of the lighting device also serve as the major mechanical members of the entire module. A liquid crystal module is completed by installing, to the backlight, the followings: the panels which have been mounted, a liquid crystal display controller including a panel drive circuit and a signal distributor, a light source power supply, and a general household power source (depending on the situation). A liquid crystal display device of the present invention is realized by installing, to the backlight, the panels which have been mounted and a frame body for pressing the panels.

In the present embodiment, a direct lighting device using a hot cathode fluorescent tube is described. However, depending on the purpose, the lighting device may be a projection type or an edge light type. Also, the light source may be a cold cathode fluorescent tube, an LED, an OEL, an electron beam fluorescent tube, or the like. Further, a combination with an optical sheet or the like may be adopted as needed.

As a means for controlling a direction of an orientation of vertical alignment liquid crystal molecules in liquid crystal, in the foregoing embodiment, a slit is provided on a pixel electrode of an active matrix substrate, and a projection for alignment control is provided on a color filter substrate. In addition to this arrangement, the following arrangements are also possible: (i) an arrangement where a slit is provided on a color filter substrate and a projection for alignment control is provided on a pixel electrode of an active matrix substrate; (ii) an arrangement where a slit is provided on each electrode of an active matrix substrate and a color filter substrate; and (iii) an MVA liquid crystal panel having a projection for alignment control on each electrode surface of an active matrix substrate and a color filter substrate.

Furthermore, besides the MVA method, the following method may also be possible: a method using a vertical alignment film in which a pre-tilt direction (i.e., an alignment direction) is perpendicular to another pre-tilt direction, the pre-tilt direction being defined by one pair of alignment films. Also, a VA mode in which liquid crystal molecules are twist-aligned is possible. Such a VA mode may be called a VATN (Vertical Alignment Twisted Nematic) mode. The VATN method is more preferable for the present invention because contrast is not reduced by leakage light at a projection for alignment control in the VATN method. Pre-tilting is created by an optical alignment or the like.

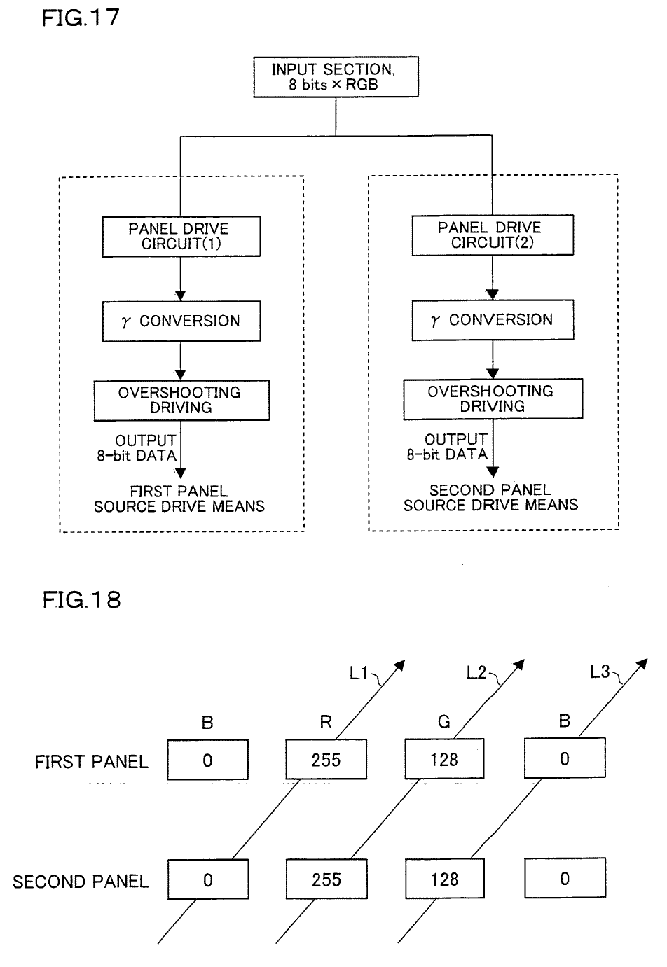

With reference to FIG. 17, the following describes one of the embodiments for a driving method used by a display controller in the liquid crystal display device 100 having the foregoing arrangement. The description given here deals with an input of 8 bits (256 gray scales) and a liquid crystal driver of 8 bits.

In a panel drive circuit (1) in the display controller, an input signal (i.e., an image source) is subjected to drive signal processes such as a γ conversion process and an overshooting process. Then, gray scale data of 8 bits is outputted to a source driver (i.e., source drive means) of the first panel.

In a panel drive circuit (2), signal processes such as a γ conversion process and an overshooting process are carried out. Then, gray scale data of 8 bits is outputted to a source driver (i.e., source drive means) of the second panel.

Each of the images inputted to the first panel and the second panel is an 8-bit image. Also, the output image which is subsequently outputted is an 8-bit image. That is, the output image corresponds to the input signal in a ratio of 1:1. This means that the output image is faithful to the input image.

Japanese Unexamined Patent Application Publication, Tokukaihei, No. 5-88107 describes that each gray scale of the panels does not always increase in an ascending order when an output changes from a low gray scale to a high gray scale. The following describes an example of changes in gray scales in response to a change in brightness. Here, a gray scale is described as “(the gray scale of the first panel, the gray scale of the second panel)”. When brightness increases in the order of 0, 1, 2, 3, 4, 5, 6, . . . , the gray scale changes as follows: (0, 0), (0, 1), (1, 0), (0, 2), (1, 1), (2, 0). That is, the gray scale of the first panel changes in the order of: 0, 0, 1, 0, 1, and 2; the gray scale of the second panel changes in the order of: 0, 1, 0, 2, 1, and 0. As such, the gray scale of each panel does not increase monotonically. However, most of signal processing methods (such as an overshooting driving) used in a liquid crystal display device uses an algorithm using an interpolation calculation. Therefore, the gray scale must increase (or decrease) monotonically. If the gray scale does not increase monotonically as described above, all pieces of the gray scale data need to be stored in a memory. This increases the size of a display control circuit and an IC, thereby leading to an increase in cost.

The first panel and the second panel are overlapped with each other as described above. In this arrangement, if 100% of light outputted from a dot on the second panel enters a corresponding dot on the first panel, the information contained in the dot will not be lost and all pieces of the information will be displayed. However, the distance between the two panels is not 0 because the panels have, for example, a glass substrate, a polarization plate and the like therebetween. In addition, a light source for the liquid crystal display device uses a diffusion light system which is not a complete parallel light source. Therefore, when both of the first panel and the second panel carry out color displaying, a color shift will occur in display light at an oblique viewing angle because color of the target dot are mixed with colors of the dots which are located around the target dot.

In view of this, in a liquid crystal display device of the present invention, in which a first panel and a second panel are overlapped with each other, only one of the panels carries out color displaying, and the other panel carries out a brightness adjustment only. That is, to the panel carrying out color displaying, a signal which has the following feature is inputted: a signal for providing R, G, and B having different brightness in accordance with an image to be displayed. On the other hand, to a panel carrying out a brightness adjustment only, a signal which has the following feature is inputted: a signal for providing R, G, and B having the same brightness (i.e., R=G=B) for all pixels. The signals are inputted to the panels in the liquid crystal display device of the present embodiment as follows.

Firstly, with reference to FIG. 18, the following describes a problem of a color shift occurring when the same image signal is inputted to the two panels being overlapped with each other. FIG. 18 shows an example where a displaying process for a signal of (R, G, B)=(255, 128, 0) is carried out. In this example, the signal is inputted to both of the first panel and the second panel.

FIG. 18 illustrates Display Light L1 through L3 which provides a visible image viewed at an oblique angle. Display Light L1, which goes through an R pixel on a first panel, also goes through a B pixel on a second panel. As a result, the light of L1 is affected by transmissivity, thereby changing into the light of (R, G, B)=(0, 0, 0). This is because the light of L1 is affected by the transmissivity of both of the R pixel on the first panel and the B pixel on the second panel (light is affected by a pixel having lower transmissivity).

Similarly, the light of L2 goes through a G pixel on the first panel and an R pixel on the second panel, thereby changing into the light of (R, G, B)=(128, 128, 0). Also, the light of L3 goes through a B pixel on the first panel and a G pixel on the second panel, thereby changing into the light of (R, G, B)=(0, 0, 0). That is, when the visible image made of Display Light L1 through L3 is viewed at an oblique angle, the visible image becomes (R, G, B)=(128, 128, 0), which is shifted from the original display signal of (R, G, B)=(255, 128, 0).

In order to avoid the color shift, for example, a case is considered where a first panel carries out a brightness adjustment only and a second panel carries out color displaying. That is, a displaying process for (R, G, B)=(128, 64, 0) is carried out such that: a signal of (R, G, B)=(128, 128, 128) is inputted to the first panel; and a signal of (R, G, B)=(128, 64, 0) is inputted to the second panel. That is, maximum brightness for each color component included in the display signal is inputted to all pixels on the first panel, which carries out a brightness adjustment; the display signal is inputted to the second panel, which carries out color displaying.

When the foregoing input signals are supplied, the display brightness for the visible image becomes (R, G, B)=(64, 32, 0). That is, the ratio between R, G, and B in the display brightness is 2:1:0, which is the same as that in the display signal. Here, it is assumed that the target display brightness of (128, 64, 0) can be obtained in accordance with the display signal if brightness of the backlight is adjusted. Actually, however, a display image which properly corresponds to the display signal cannot be obtained unless a γ value is taken into consideration. The detail of the reason for this is described below.

Generally, in a liquid crystal panel, a gray scale is not proportional to display brightness. Here, a display gray scale is denoted as L, the maximum display gray scale (255) is denoted as Lmax, display brightness is denoted as T, and maximum display brightness is denoted as Tmax. A relationship between a display gray scale and display brightness is approximately represented by the following equation:

T/Tmax=(L/Lmax)̂γ

The symbol “γ” in the equation represents a γ value. It is known that an ideal relationship between a display gray scale and display brightness can be obtained when the γ value is 2.2.

In such an arrangement as in the present invention where two liquid crystal panels are overlapped with each other, a total γ value of the two panels should be 2.2. When each the γ value of the first panel and the second panel is set at 1.1 so as to obtain the total γ value of 2.2, a problem as described below will occur.

For example, a displaying process for (R, G, B)=(128, 64, 0) is carried out as follows: a signal of (R, G, B)=(128, 128, 128) is inputted to the first panel; and a signal of (R, G, B)=(128, 64, 0) is inputted to the second panel, as described above. Here, the display signal of (R, G, B)=(128, 64, 0) is assumed to be displayed when a γ value is 2.2.

In this case, display brightness of (R, G, B)=(64, 32, 0) can be obtained in accordance with the display signal, and its ratio between R, G, and B is 2:1:0, which is the same as the ratio in the display signal. However, a γ value for a display image is 1.1 because this ratio is given only by the second panel carrying out color displaying. That is, in this case, although the ratio between R, G, and B in the display brightness is the same as the ratio between R, G, and B in the display signal, the display image thus obtained does not properly correspond to the display signal.

The following is considered as one of the measures for preventing the foregoing problem: a higher γ value is set in a panel carrying out color displaying (the second panel, in the foregoing example); and a lower γ value is set in a panel carrying out a brightness adjustment (the first panel, in the foregoing example). For example, a γ value of the second panel is set at 1.6, and a γ value of the first panel is set at 0.6. This achieves a display image having a brightness ratio closer to a brightness ratio in a display signal, compared to a case where a γ value of each of the panels is set at 1.1. Note that each γ value of two panels should be set so that a total γ value of the two panels becomes 2.2.

Thus, setting a higher γ value in a panel carrying out color displaying allows to obtain a display image having a brightness ratio which is close to a brightness ratio in a display signal. At the same time, however, this measure makes a γ value in a panel carrying out a brightness adjustment lower, therefore cannot be a substantial solution. For example, when a γ value of a first panel is set at 0 as maximum brightness and a γ value of a second panel is set at 2.2, a problem will not occur. However, it is obvious that this setting does not give an effect originally aimed at, such as maintaining a sufficient gray scale when brightness changes; and displaying in high contrast. Just the same, there is no doubt that an image which is more natural can be obtained when a γ value of a second panel becomes closer to 2.2.

In view of this, a liquid crystal display device of the present embodiment changes each γ value of a first panel and a second panel in accordance with a display signal which is inputted.

For example, the first panel has a gray scale-brightness characteristic being represented in a reverse-S shape, in which (i) a γ value on a lower gray scale side is relatively lower and (ii) a γ value on a higher gray scale side is relatively higher. On the other hand, the second panel has a gray scale-brightness characteristic being represented in an S shape, in which (iii) a γ value on a lower gray scale side is relatively higher and (iv) a γ value on a higher gray scale side is relatively lower. Each the γ value of the panels changes at X gray scale which is properly determined, for example, in the vicinity of 224 gray scales. When display brightness is high, brightness in the vicinity of X gray scale is set to become relatively high in the first panel. For example, when the maximum input gray scale is 64, the value of 64 is changed to a value in the vicinity of X (for example, 220) by a γ value changing table of the first panel.

A γ value of the second panel is set so that a desired γ-curve (for example, 2.2) can be obtained in accordance with the gray scale-brightness characteristic of the first panel. At this time, a gray scale more than X gray scale cannot obtain a sufficient brightness resolution. However, considering what this setting intends to, such a gray scale rarely occurs. In addition, if such a gray scale error occurs, the error may be permitted. In other words, a small error cannot be recognized because a partial region where a high gray scale exists is shining while the entire panel is dark.

On the other hand, when the maximum input gray scale is high, brightness for X gray scale is set at almost maximum. That is, a gray scale-brightness characteristic having higher brightness is selected. In such a gray scale-brightness characteristic, for example, 224 gray scales are changed to 248 gray scales. Thus, a gray scale-brightness characteristic of the second panel is corrected so as to obtain desired brightness.

As described above, a gray scale-brightness characteristic of a first panel is dynamically changed in accordance with display brightness. This allows a second panel to achieve sufficient gray scale resolution corresponding to various levels of brightness.

A γ value may be changed by the conversion of a display signal (a gray scale signal) using an LUT (Look-Up Table). When the LUT is switched, a γ value is changed.

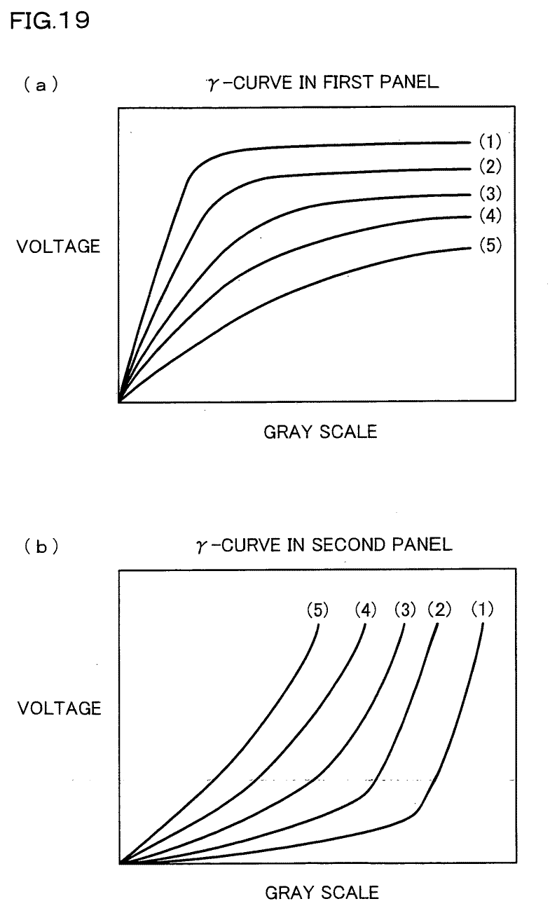

FIGS. 19 (a) and (b) illustrate a case where a plurality of γ-curves (a gray scale-brightness characteristic) are prepared each for a first panel and a second panel. In FIGS. 19 (a) and (b), five γ-curves are numbered from (1) to (5). A pair of curves having the same number are selected from a first panel and a second panel in accordance with a display signal. For example, when display brightness is high, γ-curves (1) are selected; when display brightness is low, γ-curves (5) are selected. The selection of the γ-curves is carried out by selecting an LUT corresponding to the display signal.

The above-mentioned “S shape” and “reverse-S shape” are described here. When the object of the present invention is only for realizing sufficient gray scale resolution in a second panel in accordance with a brightness level, settings such as in FIGS. 19 (a) and (b) may be used. The settings for the γ value can generally satisfy brightness levels adjoining each other in a situation where a dynamic range of an input signal is supposed not to be changed rapidly.

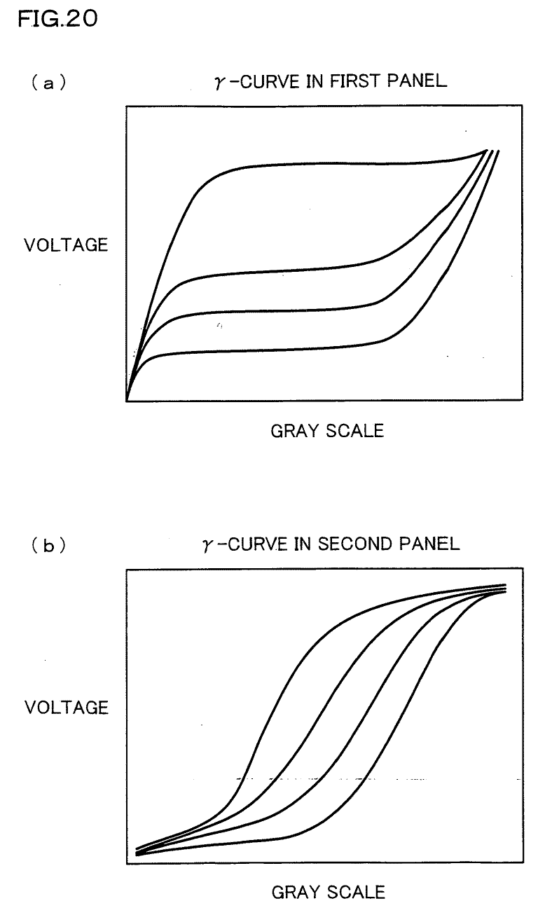

However, embodiments to which the present invention is the most likely to be applied are associated with television displaying. Therefore, there is a high possibility that brightness being far from an average occurs suddenly. When such brightness occurs suddenly in the settings of FIGS. 19 (a) and (b), it is impossible to carry out a displaying process in an “especially dark region” and an “especially bright region”, particularly in the “especially bright region”. If a γ value is changed rapidly in accordance with a signal for the purpose of preventing this problem, an adverse effect such as a contrast difference between blocks can be observed. In view of this, as shown in FIGS. 20 (a) and (b), a γ-curve of a first panel is set in a “reverse-S shape”, and a γ-curve of a second panel is set in an “S shape”. This makes it possible to carry out a displaying process even in the gray scale region where a displaying process is difficult to carry out, thereby reducing the possibility of causing the foregoing problem.

A γ-curve of an LCD1 illustrated in FIG. 20 (a) changes to a relatively large extent. On the other hand, a γ-curve of an LCD2 illustrated in FIG. 20 (b) just becomes a curve having a γ value close to 2 basically, but actually does not change to as much extent as illustrated in the graph. For a system actually used, the following method is recommended: Firstly, the γ-curve of the LCD1 is determined; then, the γ-curve of the LCD2 is adjusted so that a total γ value of 2.2 can be obtained.

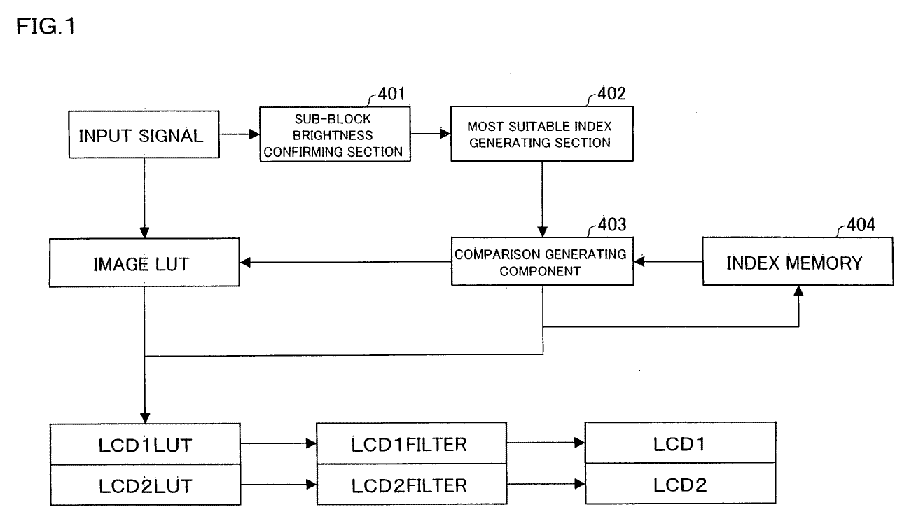

Next, with reference to FIG. 1, the following description deals with a drive signal processing algorithm which allows to select a γ-curve.

Firstly, the maximum brightness is worked out for each sub-block (e.g., a sub-block of 8×8 pixels) of an input signal (i.e., a gray scale signal) in a sub-block brightness confirming section 401. Then, the most suitable index corresponding to the maximum brightness is generated in a most suitable index generating section 402. An index number is assigned to LUTs, starting from an LUT which becomes the most suitable first when display brightness is high. Generating the most suitable index is, in other words, selecting a γ-curve which is the most suitable for display brightness of each sub-block.

After the most suitable index is generated, the most suitable index is compared by a comparing generating section 403 with an index which is set for the sub-block in a frame immediately before a current frame. The index which is set in the frame immediately before the current frame is stored in an index memory 404. When the most suitable index is higher than the index which is set in the frame immediately before the current frame, the index stored in the index memory is increased by one, so as to become closer to the most suitable index. On the other hand, when the most suitable index is lower than the index which is set in the frame immediately before the current frame, the index stored in the index memory is decreased by one, so as to become closer to the most suitable index. That is, the following LUT is selected: an LUT which is close to an LUT used for a frame immediately before a current frame, and which is closer to the most suitable LUT than is the frame immediately before the current frame.

Subsequently, an LUT for a first panel LCD1 (i.e., an LCD1LUT) and an LUT for a second panel LCD2 (i.e., an LCD2LUT) are selected in accordance with the index stored in the index memory thus rewritten.

The input signal is converted by an image LUT into a signal for the LCD1 and a signal for the LCD2. The signal for the LCD1 is inputted to the LCD1LUT thus selected; and the signal for the LCD2 is inputted to the LCD2LUT thus selected. Then, the signals are subjected to a signal conversion (i.e., a γ correction). The signal for the LCD1 is inputted to the LCD1 via an LCD1 filter; and the signal for the LCD2 is inputted to the LCD2 via an LCD 2 filter. The LCD1 filter includes a low-pass filter for achromatizing. The LCD2 filter includes a high-pass filter for enhancing color saturation.

The reason why the high-pass filter for enhancing color saturation is used is as follows. As described above, when a total γ value of two panels which are overlapped with each other is set at 2.2, a γ value of a second panel is shifted to become lower than 2.2. As a result, a γ value assumed by a display signal to be inputted is deviated from 2.2, and thereby a color balance is changed, unavoidably. Therefore, when each gray scale signal for R, G, and B is not equal to one another in a picture element composed of R, G, and B pixels, brightness ratio between R, G, and B needs to be corrected to a desired ratio in accordance with gray scale information.

In order to simplify the description, the following description deals with R and G only.

The following case is described as one of the examples. R and G represent a brightness value in a display signal which is inputted, and R′ and G′ represent a brightness value corrected for enhancing color saturation. Here, the following equation is established by assuming R:G=1:2 and α=(G−R)/2.

R′:G′=(R−α):(G+α)=(1−0.5):(2+0.5)=1:5

Thus, a contrast ratio is enhanced dramatically. Also, at this time, an average of R and G is 1.5, and an average of R′ and G′ is also 1.5. That is, an entire gamma characteristic is hardly changed.

A method for enhancing color saturation in the present invention is based on the foregoing principle, and has some restrictions. Examples of the restrictions encompass: (1) no change in R=G=B; (2) no change for a primary color (0 except for a color to be focused), a complementary color (225 except for a color to be focused), and the like. It is very preferable to have these restrictions so as to avoid a change in an entire γ value.

According to the foregoing principle, an algorithm for converting brightness values r, g, and b (in a display signal which is inputted) into brightness values r′, g′ and b′ (corrected for enhancing color saturation) is generalized as follows:

r′=r+f*k(r)*(k(g)*(r−g)+k(b)*(r−b))

g′=g+f*k(g)*(k(b)*(g−b)+k(r)*(g−r))

b′=b+f*k(b)*(k(r)*(b−r)+k(g)*(b−g))

The symbol f in the equations above is a parameter representing a correction intensity. The symbols k(r), k(g), and k(b) are a parameter for realizing the foregoing restrictions. For example, it is preferable to set the parameter as follows:
In a case of g<128, k(g)=g/255
In a case of g≧128, k(g)=(255−g)/255

Generally, setting the parameters as k(b)=k(g)=k (r) does not cause a practical problem. However, it is more preferable to consider each luminosity factor of r, g, and b and to carry out a process including a degamma correction so as to ensure an average value of brightness. At the same time, the process may cause a problem in mounting, for example, a problem that the size of a circuit increases. Therefore, the process does not always need to be carried out completely, but may be realized to a proper level depending on the situation.

The symbol f is a parameter representing a correction level, and adjusts the amount of correction in the foregoing algorithm. This parameter may be set for each color, in accordance with the size of a circuit and an image level, or may be included in k(g), k(r), k(b), and the like.

In the foregoing algorithm, a sub-block brightness confirming section works out the maximum brightness per sub-block having a predetermined number of pixels. This is for achieving a consistency in a gray scale between pixels adjoining each other and between blocks adjoining each other. A gray scale-brightness characteristic of an index cannot be completely consistent with a gray scale-brightness characteristic of another index because a gray scale expression is selected from a predetermined LUT. Therefore, when a small region has a plurality of pixels having brightness whose index is near to change, extracting brightness from every pixel or from an extremely small block causes a rough expression; and extracting brightness from an extremely large block causes a contrast difference between blocks. An appropriate size of the block from which brightness is extracted varies by the brightness, the pixel size, and the like, each of which is assumed by a display device. That is to say, the appropriate size varies by the purpose. When the purpose is for reproducing a precise signal such as in a master monitor for business-use, the size of a block is set to be relatively small. On the other hand, in a large television for household-use or a camera monitor and a picture monitor for business-use, the size of a block is set to be relatively large. The size of a sub-block is not limited to 8×8 pixels. However, when the sub-block of 8×8 pixels is used together with a block whose size is used for jpeg, mpeg and the like, an image is hardly interfered by a block noise which is generated by a signal. For this reason, the size of a sub-block which is preferably used is: a size of 8×8 pixels; or a size of 8×8 pixels multiplied by an integral number.

The reason why an index stored in an index memory is increased or decreased by one is as follows: If an index stored in an index memory is rapidly changed so as to become the most suitable index, the amount of change in brightness of a display screen becomes too large, and thereby a flicker on the display screen is caused.

An image LUT which converts an input signal into a signal for an LCD1 and a signal for an LCD2 generally carries out the following signal conversion.

A signal for an LCD1 is a signal in which all pixels have the ratio of R=G=B because a first panel LCD1 is for carrying out a brightness adjustment only. Therefore, a signal for the LCD1 is generated by (i) obtaining a maximum value from an RBG signal in each pixel in an input signal and (ii) supplying the maximum value to all components in the RGB signal. The input signal may be used as a signal for an LCD2 without carrying out any processes because the second panel LCD2 is for carrying out color displaying.

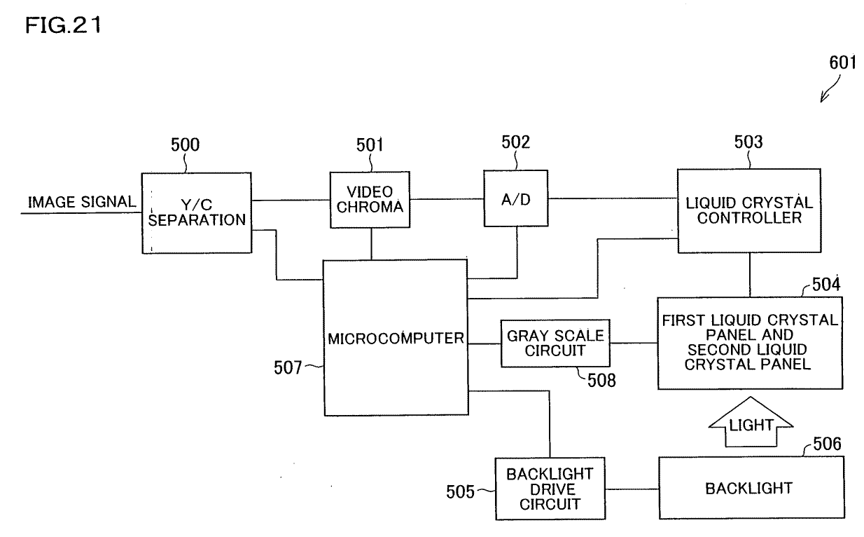

A television receiver to which a liquid crystal display device of the present invention is applied is described below with reference to FIGS. 21 through 23.

FIG. 21 illustrates a block diagram of a circuit used in a liquid crystal display device 601 for a television receiver.

The liquid crystal display device 601 includes, as shown in FIG. 21, a Y/C separation circuit 500, a video chroma circuit 501, an A/D converter 502, a liquid crystal controller 503, a liquid crystal panel 504, a backlight drive circuit 505, a backlight 506, a microcomputer 507, and a gray scale circuit 508.

The liquid crystal panel 504 has an arrangement having two liquid crystal panels (i.e., a first liquid crystal panel and a second liquid crystal panel). Also, the liquid crystal panel 504 may have any arrangement out of the arrangements described in the foregoing embodiments.

In the liquid crystal display device 601 having the foregoing arrangement, an input image signal of a television signal is firstly inputted to the Y/C separation circuit 500, thereby being separated into a brightness signal and a color signal. The brightness signal and the color signal are converted by the video chroma circuit 501 into R, G, and B, which are three primary colors of light. Then, the analog RGB signal is converted by the A/D converter 502 into a digital RGB signal, and the RGB digital signal is inputted to the liquid crystal controller 503.

The RGB signal is inputted from the liquid crystal controller 503 to the liquid crystal panel 504 in a predetermined timing, and each gray scale voltage for R, G, and B is also supplied from the gray scale circuit 508 to the liquid crystal panel 504. This allows to display an entire image. The microcomputer 507 carries out entire operation of the system including these processes.

Examples of the image signal may encompass: an image signal in accordance with television broadcasting; an image signal which is taken by a camera; an image signal supplied via the Internet connection; and the like. An image can be displayed in accordance with various kinds of image signals.

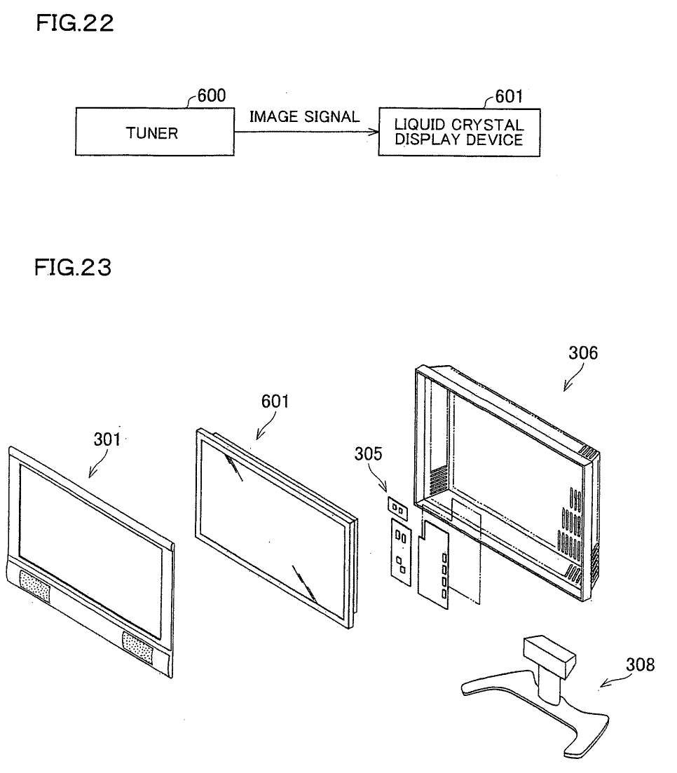

A tuner 600 shown in FIG. 22 receives television broadcasting, and then outputs a video signal. The liquid crystal display device 601 carries out an image (or video) displaying process in accordance with the video signal outputted by the tuner 600.

When the liquid crystal display device having the foregoing arrangement is a television receiver, the television receiver has, for example, the following arrangement as shown in FIG. 23: A liquid crystal display device 601 is sandwiched and embraced between a first housing 301 and a second housing 306.

The first housing 301 has an opening 301a through which an image being displayed on the liquid crystal display device 601 goes through.

The second housing 306 is for covering the backside of the liquid crystal display device 601. Also, the second housing 306 is provided with (i) an operation circuit 305 for operating the liquid crystal display device 601 and (ii) a supporting part 308 at the bottom of the second housing 306.

When a liquid crystal display device of the present invention is used as a display device in a television receiver having the foregoing arrangement as described above, it is possible to display an image having: extremely high display quality; high contrast; and no reduction in color saturation.

As described above, a liquid crystal display device of the present invention is a drive method for a liquid crystal display device including: (i) two or more liquid crystal panels being overlapped with each other, each of the liquid crystal panels outputting an image in accordance with an image source; and (ii) polarized light absorbing layers sandwiching the liquid crystal panels therebetween, the polarized light absorbing layers being arranged in a crossed Nicols state, wherein one liquid crystal panel out of the liquid crystal panels being overlapped with each other is a first panel that carries out a brightness adjustment and the other liquid crystal panel is a second panel that carries out color displaying, and a γ value in each display signal being outputted to the first panel and the second panel is changed in accordance with a gray scale in the image source.

In view of this, the polarized light absorbing layer is arranged in a crossed Nicols state with a polarized light absorbing layer of the liquid crystal panel, the polarized light absorbing layers adjoining each other. For example, this gives the following effects: (i) In a view from the front, when leakage light occurs in a direction of a transmission axis of the polarized light absorbing layer, the leakage light is shut off by an absorption axis of the other polarized light absorbing layer; (ii) In a view from an oblique angle, even if a Nicol angle is broken (the Nicol angle is an angle created by the cross of the polarization axes of the polarized light absorbing layers adjoining each other), the amount of light caused by leakage light does not increase. That is, when a Nicol angle becomes large at an oblique viewing angle, black is less apt to be grayish.

Thus, when two or more liquid crystal panels are overlapped with each other, the number of polarized light absorbing layers is not less than three. That is, it is possible to largely improve shutter performance both in a view from the front and in a view from an oblique angle by having three polarized light absorbing layers being arranged in a crossed Nicols state with each other. This improves contrast significantly.

One liquid crystal panel out of the liquid crystal panels being overlapped with each other is a first panel that carries out a brightness adjustment, and the other liquid crystal panel is a second panel that carries out color displaying. In this case, a γ value in each display signal being outputted to the first panel and the second panel is changed in accordance with the gray scale in an image source.

For example, the first panel has a gray scale-brightness characteristic being represented in a reverse-S shape, in which (i) a γ value on a lower gray scale side is relatively lower and (ii) a γ value on a higher gray scale side is relatively higher. On the other hand, the second panel has a gray scale-brightness characteristic being represented in an S shape, in which (iii) a γ value on a lower gray scale side is relatively higher and (iv) a γ value on a higher gray scale side is relatively lower. Each the γ value of the panels changes at X gray scale which is properly determined, for example, in the vicinity of 224 gray scales. When display brightness is high, brightness in the vicinity of X gray scale is set to become relatively high in the first panel. For example, when the maximum input gray scale is 64, the value of 64 is changed to a value in the vicinity of X (for example, 220) by a γ value changing table of the first panel.

A γ value of the second panel is set so that a desired γ-curve (for example, 2.2) can be obtained in accordance with the gray scale-brightness characteristic of the first panel. At this time, a gray scale more than X gray scale cannot obtain a sufficient brightness resolution. However, considering what this setting intends to, such a gray scale rarely occurs. In addition, if such a gray scale error occurs, the error may be permitted. In other words, a small error cannot be recognized because a partial region where a high gray scale exists is shining while the entire panel is dark.

On the other hand, when the maximum input gray scale is high, brightness for X gray scale is also set almost at maximum. That is, a gray scale-brightness characteristic having higher brightness is selected. In such a gray scale-brightness characteristic, for example, 224 gray scales are changed to 248 gray scales. Thus, a gray scale-brightness characteristic of the second panel is corrected so as to obtain desired brightness.

That is to say, a gray scale-brightness characteristic of the first panel is dynamically changed in accordance with display brightness. This allows the second panel to achieve sufficient gray scale resolution corresponding to various levels of brightness.

Also, in the liquid crystal display device, it is preferable that the change of a γ value is carried out per sub-block having a predetermined number of pixels.

With the foregoing arrangement, the most suitable γ value is set for each sub-block having a predetermined number of pixels. Compared to a method in which a γ value is set for each pixel, this method reduces a flicker in an image, thereby realizing better displaying.

In addition, in the crystal liquid display device, it is preferable that the change of a γ value is to be carried out by switching an LUT to another LUT on which a γ correction is to be carried out.

In the liquid crystal display device, the change of a γ value is carried out, by switching an LUT to another LUT on which a γ correction is to be carried out, per sub-block having a predetermined number of pixels. In addition, it is preferable to carry out the change of a γ value by: (i) determining a most suitable LUT for average brightness in the sub-blocks; and (ii) selecting an LUT which is close to an LUT used for a frame immediately before a current frame, and which is closer to the most suitable LUT than is the frame immediately before the current frame.

This arrangement can prevent a γ value which is set from being changed from a γ value in a frame one frame ahead of a current frame. This suppresses a flicker on a display screen caused by a too large amount of change in brightness of the display screen.

In addition, this minimizes a contrast difference between blocks which occurs when the following two types of sub-blocks adjoin each other: (i) a sub-block having a sudden change in brightness; and (ii) a sub-block having less change in brightness.

### INDUSTRIAL APPLICABILITY

A liquid crystal display device of the present invention is useful for television receivers, monitors for broadcasting, and the like because the liquid crystal display device is capable of improving contrast significantly.

1. A liquid crystal display device, including:
(i) two or more liquid crystal panels being overlapped with each other, each of the liquid crystal panels outputting an image in accordance with an image source; and
(ii) polarized light absorbing layers sandwiching the liquid crystal panels therebetween, the polarized light absorbing layers being arranged in a crossed Nicols state,
wherein: one liquid crystal panel out of the liquid crystal panels being overlapped with each other is a first panel that carries out a brightness adjustment and the other liquid crystal panel is a second panel that carries out color displaying; and
a γ value in each display signal being outputted to the first panel and the second panel is changed in accordance with a gray scale in the image source.

2. The liquid crystal display device as set forth in claim 1, wherein the change of a γ value is carried out per sub-block having a predetermined number of pixels.

3. The liquid crystal display device as set forth in claim 1, wherein the change of a γ value is carried out by switching an LUT to another LUT on which a γ correction is to be carried out.

4. The liquid crystal display device as set forth in claim 1, wherein:
the change of a γ value is carried out, by switching an LUT to another LUT on which a γ correction is to be carried out, per sub-block having a predetermined number of pixels; and
the change of a γ value comprises the steps of:
(i) determining a most suitable LUT for maximum brightness in the sub-block; and
(ii) selecting an LUT which is close to an LUT used for a frame immediately before a current frame, and which is closer to the most suitable LUT than is the frame immediately before the current frame.

5. A television receiver, comprising:
a tuner configured to receive television broadcasting; and
a display device configured to display the television broadcasting received by the tuner,
wherein the display device is a liquid crystal display device as set forth in claim 1.

6. A television receiver, comprising:
a tuner configured to receive television broadcasting; and
a display device configured to display the television broadcasting received by the tuner,
wherein the display device is a liquid crystal display device as set forth in claim 2.

7. A television receiver, comprising:
a tuner configured to receive television broadcasting; and
a display device configured to display the television broadcasting received by the tuner,
wherein the display device is a liquid crystal display device as set forth in claim 3.

8. A television receiver, comprising:
a tuner configured to receive television broadcasting; and
a display device configured to display the television broadcasting received by the tuner,
wherein the display device is a liquid crystal display device as set forth in claim 4.
